(19) United States
(12) Patent Application Publication
(10) Pub. No.: US 2025/0252475 A1
(43) Pub. Date: Aug. 7, 2025

(54) SYSTEM AND METHOD FOR DETERMINING AND RECOMMENDING PURCHASE OF PERIPHERAL DEVICES FOR AN EXISTING PERIPHERAL DEVICE WORKSPACE BASED ON PERIPHERAL DEVICE WORKSPACE CAPABILITIES

(71) Applicant: Dell Products, LP, Round Rock, TX (US)

(72) Inventors: Gokul Thiruchengode Vajravel, Bangalore (IN); Srinivasa Ragavan Rajagopalan, Bangalore (IN); Vivek Viswanathan Iyer, Saint Johns, FL (US)

(73) Assignee: Dell Products, LP, Round Rock, TX (US)

(21) Appl. No.: 18/429,682

(22) Filed: Feb. 1, 2024

(51) Int. Cl. G06Q 30/0601

(52) U.S. Cl. CPC G06Q 30/0631

(57) ABSTRACT

A peripheral device workspace cloud orchestrator executing on a server comprises a network interface device to receive an operational telemetry data reading indicating communication port functional capabilities for each communication port at an anchor information handling system node and for peripheral device nodes that have been previously operatively coupled to the anchor information handling system node at a location to form a defined peripheral device workspace identified by a peripheral device workspace identification value, and a hardware processor executing code instructions to identify an available port for communication via a communication protocol and identify its power delivery capabilities based on the operational telemetry data reading that is available for coupling with a new peripheral device, and to recommend that a user purchase the new peripheral device selected from a product purchase platform that can be met by the power delivery capability and communication protocol capabilities for the available port.

### FIELD OF THE DISCLOSURE

The present disclosure generally relates to automatic assessment or configuration of peripheral devices for use in a peripheral device workspace. The present disclosure more specifically relates to a specialized information handling system executing code instructions to determine recommending user purchase of peripheral devices and supporting adapters, hubs, or docking stations based on determined existing capabilities of the user's information handling system, such as available ports and peripheral device power supply and that takes into account current use connectivity of one or more existing peripheral devices operatively coupled to that information handling system within an existing peripheral device workspace.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, video communication capabilities, and audio capabilities. The information handling system may be operatively coupled to one or more wireless peripheral input/output devices such as a keyboard, mouse, touchpad, gaming controller, display device, wearable peripheral device, speakers, earbud, headphone, microphone, stylus, or other peripheral devices.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating a cloud-based information handling system operably coupled to a peripheral device workspace cloud orchestrator server executing code instructions of a peripheral device workspace cloud orchestrator to manage configuration of peripheral devices across a plurality of user peripheral device workspaces according to an embodiment of the present disclosure;

FIG. 2 is a block diagram illustrating a cloud-based peripheral device workspace cloud orchestrator server for defining a first peripheral device workspace and for executing code instructions of a workspace capability informed peripheral device purchase recommendation system as part of a peripheral device orchestrator in management of peripheral devices across a plurality of user peripheral device workspaces according to an embodiment of the present disclosure;

FIG. 3 is a flow diagram illustrating a method for executing code instructions of a workspace capability informed peripheral device purchase recommendation system for filtering search results for purchase of a new peripheral device for managed peripheral device workspaces according to an embodiment of the present disclosure; and

FIG. 4 is a flow diagram illustrating a method of executing code instructions of a workspace capability informed peripheral device purchase recommendation system for recommending user purchase of a peripheral device, port hub, port adapter, or docking station as an alternative or supplemental to a peripheral device selected for managed peripheral device workspaces according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

A user may oftentimes use an information handling system in a peripheral device workspace. In this context, a peripheral device workspace can be defined and established with a peripheral device workspace identification value in memory as a location with a manifest of nodes that includes a user information handling system (e.g., a laptop) as an anchor node and peripheral device nodes that are connected to the user information handling system. Peripheral device operational telemetry readings may be included with a peripheral device workspace under a peripheral device workspace identification value and include for example, time of day, applications being executed, wireless or wired connection capabilities of nodes, status or functionality of one or more ports of the anchor node user information handling system for connection to peripheral devices within a peripheral device workspace, security credentials for the user, and other workspace data. Peripheral devices may commonly include internal or external devices such as displays, a keyboard, a mouse, a webcam, a printer, a speaker, a fingerprint scanner, etc. A peripheral device workspace may include a wired or wireless dock by which the user information handling system connects to some or all the peripheral devices including smart peripheral devices having some compute, input/output or network capabilities.

These peripheral devices within a given peripheral device workspace may operatively couple to a user's anchor node information handling system within the peripheral device workspace via various types of ports, hubs, or docking stations. For example, peripheral devices may operatively couple to a peripheral device workspace anchor node information handling system via Universal Serial Bus (USB) standardized ports, such as USB-A, USB 2.0, USB 3.0, or USB-C, or via other standardized ports, such as High Definition Multi-Media Interface (HDMI), DisplayPort (DP), Mini-DP, or audio in/out. In addition, some of these port types may support the transfer of power via the port, such as USB-A, USB 2.0, USB 3.0, USB-C, or the USB power delivery (USB-PD) supplement to the USB-C standard, while others such as HDMI do not. In some cases, docking stations, hubs, or adapters may be used to increase the number of a certain type of port available to the user. Users routinely have a plurality of peripheral devices plugged into these ports, docking stations, hubs, or adapters, leaving only one or a few available for further connection to other peripheral devices. In addition, one or more of these ports may be disabled or non-functional at a given time. A particularized system is needed to inform the user's decision of which new peripheral devices to purchase based on the availability of ports and power supply from the information handling system when it is acting as the anchor node of the peripheral device workspace in which the user plans to incorporate the newly purchased peripheral device. Without such a particularized system, a user may purchase a peripheral device only to determine it is incompatible with the capabilities of the user's current peripheral device workspace, which may require return of the purchased peripheral device, or purchase of additional hubs, adapters, or docking stations before the user can effectively use the newly purchased peripheral device. Execution of executable code instructions of a workspace capability informed peripheral device purchase recommendation system at a peripheral device cloud orchestration server or servers for managing peripheral device workspaces in an enterprise is such a particularized system that addresses these issues by gathering port connectivity and power delivery capabilities for each of a user's peripheral device workspaces, and recommending the purchase of only peripheral devices the user's peripheral device workspace is capable of connecting to and powering according to embodiments herein.

Execution of code instructions for an ecosystem manageability sub-agent on a user information handling system monitors for sets of peripheral device operational telemetry readings of a peripheral device workspace, such as time, applications currently executing or planned, status or functionality of one or more ports of the anchor node user information handling system for connection to peripheral devices within a peripheral device workspace, connection type (e.g., wireless, wired, wireless wide area network (WWAN), wireless local area network (WLAN), wireless private area network (WPAN)), security credentials for the user, or environmental sensor readings (e.g., humidity, temperature), among other possible peripheral device operational telemetry readings for the information handling system node and peripheral device nodes in a peripheral device workspace. These peripheral device operational telemetry readings associated with a peripheral device workspace identification value may be gathered routinely in telemetry measurements, or upon each startup of an anchor information handling system, for example. The ecosystem manageability sub-agent executing at the information handling system in a peripheral device workspace may create a manifest of peripheral device nodes and other nodes for a peripheral device workspace identification value to represent the current peripheral device workspace, including an identification of the user, and an identification (e.g., by product serial number or other peripheral device identification) of each of the peripheral device nodes connected to or operably coupled to the anchor information handling system at a peripheral device workspace.

The hardware processor of the user anchor information handling system may execute code instructions of the ecosystem manageability sub-agent to also collect one or more peripheral device operational telemetry readings (e.g., time, applications executing, status or functionality of one or more ports of the anchor node user information handling system for connection to peripheral devices within a peripheral device workspace, or other telemetry data indicating usage patterns for the information handling system in a peripheral device workspace), and one or more peripheral device configuration settings (e.g., resolution for an external display device) for the operably coupled peripheral devices. The manifest of peripheral device nodes and other nodes as well as location of a peripheral device workspace described above may be combined with the peripheral device operational telemetry readings for the peripheral device workspace and an identification of the anchor node information handling system user into a peripheral device workspace anchor node status update document written in a machine-readable language or machine markup language such as JavaScript Object Notation (JSON), for example, and transmitted for storage with the peripheral device workspace identification value at a peripheral device workspace management system database operating in a cloud computing platform. Each time a peripheral device configuration setting is changed by the user, a new peripheral device is added to the peripheral device workspace, or changes to peripheral device operational telemetry readings for the peripheral device workspace is detected, a new peripheral device workspace anchor node status update document including this updated configuration may be transmitted to a workspace capability informed peripheral device purchase recommendation system executing at a peripheral device workspace cloud orchestration server with the peripheral device workspace management system.

Various peripheral device workspaces such as the hybrid work office peripheral device workspaces and other peripheral device workspaces described herein may be defined by location indicator detected for an anchor node information handling system operating at the peripheral device workspace, and a manifest of nodes of peripheral devices and smart devices that may operate in the peripheral device workspace. Each such defined peripheral device workspace may also be assigned a peripheral device workspace identification value which may be stored and associated with stored manifests of nodes operating in the peripheral device workspace. Additional peripheral device operational telemetry readings for the peripheral device workspace may be stored within one or more peripheral device workspace anchor node status update documents as well as included in the definition of the peripheral device workspace and associated with its peripheral device workspace identification value defined at the peripheral device workspace management system database, including peripheral device capabilities, peripheral device connectivity details, current peripheral device configurations or settings, peripheral device setting or configuration options, current status of the peripheral devices within the peripheral device workspace, and other features of nodes within the peripheral device workspace. For example, the definition of the peripheral device workspace associated with a specific peripheral device workspace identification value may include a set of peripheral device operational telemetry readings stored within one or more peripheral device workspace anchor node status update documents, such as time, applications currently executing or planned, connection type, functionality of ports for the anchor node information handling system, or environmental sensor readings (e.g., humidity, temperature), among other possible environmental context telemetry readings for an anchor node information handling system operating within the defined peripheral device workspace.

A memory database for the peripheral device workspace management system may further store a user composite peripheral device workspace identifier that is unique to individual users of one or more defined peripheral device workspaces that are associated with identification of the user or the user's information handling system and peripheral device workspace identification values of the peripheral device workspaces used by that user. Thus, a user composite peripheral device workspace identifier may identify a single user of an anchor node information handling system, and a peripheral device workspace identification value for each of one or more peripheral device workspaces in which the user's information handling system operates as an anchor node at various times. The user composite peripheral device workspace identifier may thus be user-specific and user-centric. The peripheral device workspace identification value, in comparison, may define a location and list of peripheral device nodes, and may thus be peripheral device workspace-centric.

A user may visit an online product purchase platform for purchase of a new peripheral device for incorporation within an existing peripheral device workspace associated with that user's user composite peripheral device workspace identifier and managed by a peripheral device workspace cloud orchestrator executing on a peripheral device workspace cloud orchestrator server or servers. The product purchase platform may work in tandem with the workspace capability informed peripheral device purchase recommendation system of the peripheral device workspace cloud orchestrator to prompt the user to log in using the user composite peripheral device workspace identifier. Execution of code instructions of the workspace capability informed peripheral device purchase recommendation system may then prompt the user to identify or determine from user associated peripheral device workspaces that one of a plurality of the peripheral device workspaces associated with that user composite peripheral device workspace identifier is one into which the user plans to incorporate the peripheral device being purchased. Code instructions of a workspace capability informed peripheral device purchase recommendation system operating at a peripheral device workspace cloud orchestrator server may then execute to retrieve a peripheral device workspace anchor node status update document associated with that user-selected peripheral device workspace. The retrieved peripheral device workspace anchor node status update document may include a current status for the connectivity between the anchor node information handling system and one or more peripheral devices within the user-identified peripheral device workspace. This may include, for example, a description of a number and type of available and currently functioning ports for potential connection to the peripheral device being purchased and the peripheral devices within the already established peripheral device workspace to which the user wishes to add the newly purchased peripheral device.

In some embodiments, code instructions of the workspace capability informed peripheral device purchase recommendation system may be executed to work in tandem with the product purchase platform to then filter the search results at the product purchase platform for peripheral devices available to purchase according to the determined port availability and power capability limitations determined directly above for management of nodes for the peripheral device workspace. In other embodiments, code instructions of the workspace capability informed peripheral device purchase recommendation system may be executed to work in tandem with the product purchase platform to allow the user to shop without such a filter, and may recommend any extra hardware needed to support such an unfiltered purchase selection based on the determined port availability and power capability limitations determined above. For example, the user may select a peripheral device for purchase from a search result that has not been filtered to accommodate the port availability and functionality retrieved from the peripheral device workspace anchor node status update document. In other words, the user's anchor node information handling system for the user-selected peripheral device workspace in which the user wishes to incorporate the newly purchased peripheral device may or may not have the port connectivity and power delivery capabilities needed to operatively couple with the peripheral device chosen for purchase by the user within the user's chosen peripheral device workspace without disconnecting other peripheral devices within that peripheral device workspace or purchasing additional hardware such as hubs, adapters, or docking stations. In such a case, upon the user's selection of the peripheral device for purchase, code instructions for the workspace capability informed peripheral device purchase recommendation system may execute to work in tandem with the product purchase platform to recommend the user adjust the selection of the peripheral device for purchase and incorporation within the user-selected peripheral device workspace, or purchase additional supporting hardware for incorporation within the user-selected peripheral device workspace.

Each peripheral device available for purchase at the product purchase platform may be associated with an orchestrated device descriptor (ODD) which includes a description of all non-configurable aspects of the peripheral device available for purchase, such as the type of port connection(s) required for operative coupling with a peripheral device workspace anchor node information handling system and power delivery requirements via those connections, if any. The orchestrated device descriptor may also identify the configurable capabilities of such a device and may be accessible by the product purchase platform. Code instructions for the workspace capability informed peripheral device purchase recommendation system may execute to compare the non-configurable capabilities of the peripheral device the user wishes to purchase, as described within the retrieved orchestrated device descriptor, to the port connectivity and power delivery capabilities for the user's information handling system as defined within the retrieved peripheral device workspace anchor node status update document. In some cases, the recently measured or monitored information handling system port connectivity and power delivery capabilities given within the retrieved peripheral device workspace anchor node status update document meet the non-configurable capabilities of the peripheral device selected for purchase and incorporation within the user-selected peripheral device workspace defined, at least in part according to the retrieved peripheral device workspace anchor node status update document. In such a case, code instructions for the workspace capability informed peripheral device purchase recommendation system may execute to notify the product purchase platform to allow the user to proceed with the purchase of the peripheral device intended for incorporation within the user-selected peripheral device workspace defined by that peripheral device workspace anchor node status update document without any further recommendation. In other words, code instructions for the workspace capability informed peripheral device purchase recommendation system may execute to notify the product purchase platform to allow the user to proceed with the purchase without any further recommendation when it is determined that the anchor node information handling system for the peripheral device workspace in which the user intends to incorporate the purchased peripheral device currently has an available and operable port available for connection with the peripheral device selected for purchase, and any power requirements for that device may be met through delivery of power via the available port.

In some cases, the anchor node information handling system for the peripheral device workspace in which the user plans to incorporate the newly purchased peripheral device may not currently have an available and operable port of the connectivity type (e.g., USB-C) required for operative connection with the newly purchased peripheral device. In such a scenario, code instructions for the workspace capability informed peripheral device purchase recommendation system may execute to automatically recommend purchase of another peripheral device instead, or may recommend purchase of supporting hardware in addition to the chosen peripheral device for incorporation within the user-selected peripheral device workspace in which the peripheral device being purchased is intended for use to accommodate expansion of available connectivity type, additional power sources, or the like. For example, if other port types (e.g., USB-A or USB 2.0) are available and operable at the anchor node information handling system for the peripheral device workspace in which the user intends to incorporate the newly purchased peripheral device, code instructions for the workspace capability informed peripheral device purchase recommendation system may execute to identify another model of the peripheral device the user has selected for purchase that supports the available and operable port type (e.g., USB-A, or USB 2.0 rather than the user-selected USB-C). As another example, in some cases, no other port types may be available and operable at the anchor node information handling system for the peripheral device workspace in which the user plans to incorporate the newly purchased peripheral device, or other models of the peripheral device selected for purchase by the user may not support available port connection types. In such a scenario, code instructions for the workspace capability informed peripheral device purchase recommendation system may execute to identify an additional port hub or adapter for recommended purchase and incorporation into the peripheral device workspace into which the user intends to incorporate the newly purchased peripheral device that is capable of operatively coupling the peripheral device selected for purchase to an existing port at the anchor node information handling system for the user-selected peripheral device workspace as identified within the determined connectivity of the managed peripheral device workspace. Thus, the execution of code instructions for the workspace capability informed peripheral device purchase recommendation system provide for automatic assessment and determination of connectivity and power availability compatibility in managed peripheral device workspaces during purchasing without requiring an ITDM to conduct surveys or assessments or requiring a disconnection of another peripheral devices already established within the peripheral device workspace into which the user intends to incorporate the newly purchased peripheral device.

In any of these scenarios, code instructions for the workspace capability informed peripheral device purchase recommendation system may then execute to determine whether the available port at the anchor node information handling system for the peripheral device workspace into which the user intends to incorporate the newly purchased peripheral device, along with any additional recommended hardware (e.g., port hub, adapter) is capable of supplying power required for operative coupling to the peripheral device for purchase. If the available port for the anchor node information handling system within the user-selected peripheral device workspace, along with any additional recommended hardware cannot meet the power requirements for the peripheral device selected by the user for purchase, code instructions for the workspace capability informed peripheral device purchase recommendation system may execute to automatically recommend the user purchase the user-selected peripheral device, along with a docking station capable of providing the appropriate connectivity and power supply for the peripheral device selected by the user for purchase, as well as any existing peripheral devices within the peripheral device workspace into which the user intends to incorporate the newly purchased peripheral device. In such a way, code instructions for the workspace capability informed peripheral device purchase recommendation system may execute to automatically inform the user's decision of which new peripheral devices to purchase based on the availability of ports and power supply from the information handling system within the managed peripheral device workspace in which the user plans to incorporate the purchased peripheral device.

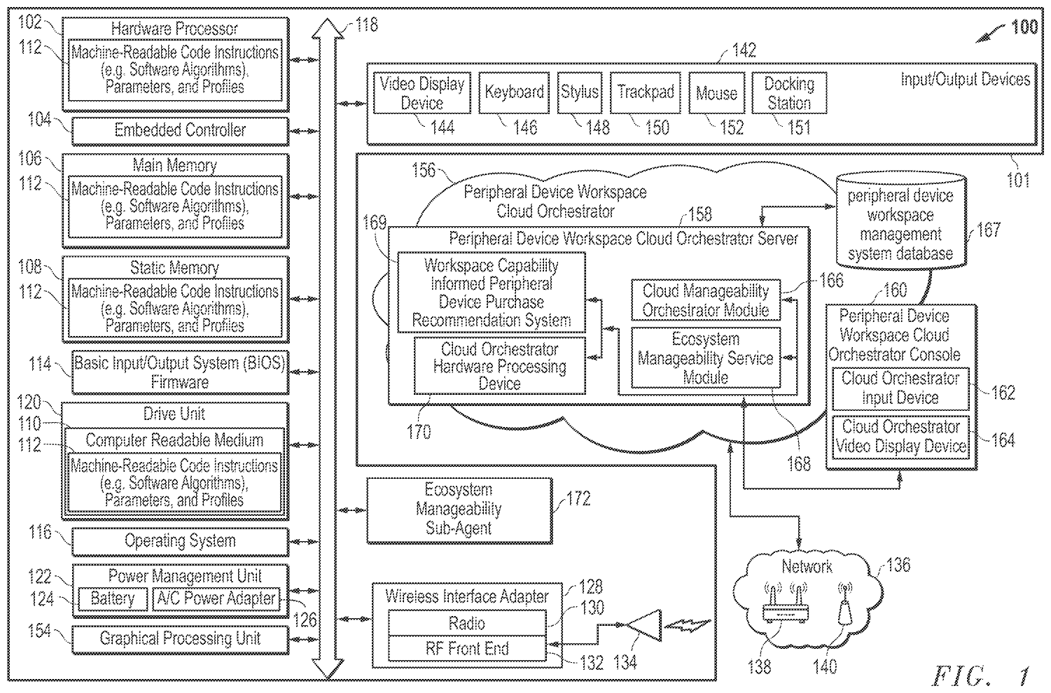

FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 138, a base station transceiver 140, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality. It is appreciated that, in some embodiments herein, the information handling system 100 may be one of a plurality of device nodes as part of a peripheral device workspace described in embodiments herein or an information handling system 100 may serve as a peripheral device workspace cloud orchestrator server 158 executing code instructions of various modules and systems of the peripheral device workspace cloud orchestrator 156 and operatively coupled to display a peripheral device workspace cloud orchestrator console 160 graphical user interface described herein.

In an embodiment, the cloud orchestrator console 160 graphical user interface may be displayed at an information handling system 100 itself that is used by an internet technology decision maker (ITDM) to create peripheral device operational configuration policies with one or more peripheral device workspace cloud orchestrator servers 158 to be propagated down to node devices within a peripheral device workspace such as the information handling system 100, a docking station 151, video display device 144, keyboard 146, stylus 148, trackpad 150, mouse 152, and the like. In this embodiment, the information handling system 100, may receive the peripheral device operational configuration policies generated by the ITDM at the peripheral device workspace cloud orchestrator console 160 graphical user interface, or generated by the peripheral device workspace cloud manageability orchestrator module 166 based on default peripheral device configuration settings via execution of code instructions of the cloud manageability orchestrator module 166 and the ecosystem manageability service module 168 at the peripheral device workspace cloud orchestrator server 158 as described in embodiments herein.

These peripheral devices 142 within a given peripheral device workspace that also includes the information handling system 100 may operatively couple to a user's anchor node information handling system 100 within the peripheral device workspace via various types of ports, hubs, or docking stations. For example, peripheral devices within 142 may connect to a peripheral device workspace anchor node information handling system 100 via Universal Serial Bus (USB) standardized ports, such as USB-A, USB 2.0, USB 3.0, or USB-C, or via other standardized ports, such as High Definition Multi-Media Interface (HDMI), DisplayPort (DP), Mini-DP, or audio in/out. In addition, some of these port types may support the transfer of power via the port, such as USB-A, USB 2.0, USB 3.0, USB-C, or the USB power delivery (USB-PD) supplement to the USB-C standard, while others such as HDMI do not. In some cases, docking stations, hubs, or adapters may be used to increase the number of a certain type of port available to the user of the information handling system 100. Users routinely have a plurality of peripheral devices such as one or more of 142 plugged into these ports, docking stations, hubs, or adapters, leaving only one or a few available for further connection to other peripheral devices. In addition, one or more of these ports may be disabled or non-functional at a given time.

A system is needed to inform the user's decision of which new peripheral devices to purchase based on the availability of ports and power supply from the information handling system 100 when it is acting as the anchor node of the peripheral device workspace in which the user plans to incorporate the newly purchased peripheral device. Without such a system, a user may purchase a peripheral device only to determine it is incompatible with the capabilities of the user's current peripheral device workspace, which may require return of the purchased peripheral device, or purchase of additional hubs, adapters, or docking stations before the user can effectively use the newly purchased peripheral device. Execution of code instructions of a workspace capability informed peripheral device purchase recommendation system 169 as part of a peripheral device workspace cloud orchestrator 156 on a peripheral device workspace cloud orchestrator server 158 in an embodiment may address these issues by gathering port connectivity and power delivery capabilities for each of a user's peripheral device workspaces, and recommending the purchase of only peripheral devices the user's peripheral device workspace is capable of connecting to and powering as part of management systems for an enterprises peripheral device workspaces.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 106, (volatile (e.g., random-access memory, etc.), or static memory 108, nonvolatile (read-only memory, flash memory etc.) or any combination thereof), one or more hardware processing resources, such as a hardware processor 102 that may be a central processing unit (CPU), a graphics processing unit (GPU) 103, embedded controller (EC) 104, or any combination thereof. Additional components of the information handling system 100 may include one or more storage devices such as static memory 108 or drive unit 120. The information handling system 100 may include or interface with one or more communications ports for communicating with external peripheral devices, such as various input and output (I/O) devices 142, including, for example, a docking station 151, a mouse 152, a trackpad 150, a keyboard 146, a stylus 148, a video/graphics display device 144, or any combination thereof. Portions of an information handling system 100 may themselves be considered information handling systems 100.

Information handling system 100 may include devices or modules that embody one or more of the devices or execute instructions for one or more systems and modules. The information handling system 100 may execute instructions (e.g., software algorithms), parameters, and profiles 112 that may operate on servers or systems, remote data centers, or on-box in individual client information handling systems according to various embodiments herein. In some embodiments, it is understood any or all portions of instructions (e.g., software algorithms), parameters, and profiles 112 may operate on a plurality of information handling systems 100.

The information handling system 100 may include the hardware processor 102 such as a central processing unit (CPU). Any of the processing resources may operate to execute code that is either firmware or software code. Moreover, the information handling system 100 may include memory such as main memory 106, static memory 108, and disk drive unit 120 (volatile (e.g., random-access memory, etc.), nonvolatile memory (read-only memory, flash memory etc.) or any combination thereof or other memory with computer readable medium 110 storing instructions (e.g., software algorithms), parameters, and profiles 112 executable by the EC 104, hardware processor 102, GPU 103, or any other hardware processing device. The information handling system 100 may also include one or more buses 118 operable to transmit communications between the various hardware components such as any combination of various I/O devices 142 as well as between hardware processors 102, an EC 104, the operating system (OS) 116, the basic input/output system (BIOS) 114, the wireless interface adapter 128, or a radio module, among other components described herein. In an embodiment, the information handling system 100 may be in wired or wireless communication with the I/O devices 142 such as a docking station 151, a keyboard 146, a mouse 152, video display device 144, stylus 148, or trackpad 150 among other peripheral devices any combination of which may form one or more various peripheral device workspaces according to embodiments herein.

The information handling system 100 further includes a video/graphics display device 144. The video/graphics display device 144 in an embodiment may function as a liquid crystal display (LCD), an organic light emitting diode (OLED), a flat panel display, or a solid-state display. It is appreciated that the video/graphics display device 144 may be wired or wireless and may be an external video/graphics display device 144 that allows a user to increase the desktop area by extending the desktop in an embodiment. Additionally, as described herein, the information handling system 100 may include or be operatively coupled to one or more other I/O devices 142 including the wired or wireless mouse 152 described herein that allows the user to interface with the information handling system 100 via the video/graphics display device 144, a cursor control device (e.g., a trackpad 150, or gesture or touch screen input), a stylus 148, and/or a keyboard 146, among others. Information handling system 100 may also be operatively coupled to a peripheral device 142 such as a docking station 151 or other smart peripheral device having a hardware processing device such as a hardware processor, microcontroller, or other hardware processing resource and which may further be operatively coupled to one or more additional peripheral devices 142. As described herein, each of these input/output devices 142 may each be a node device associated with the information handling system 100 and may be part of a peripheral device workspace defined and identified with a peripheral device workspace identification value via execution of the ecosystem manageability service module 168 and cloud manageability orchestrator module 166, as described in embodiments herein. Various drivers and hardware control device electronics may be operatively coupled to operate the I/O devices 142 according to the embodiments described herein. The present specification contemplates that the I/O devices 142 may be wired or wireless.

A network interface device of the information handling system 100 shown as wireless interface adapter 128 can provide connectivity among devices such as with Bluetooth® or to a network 136, e.g., a wide area network (WAN), a local area network (LAN), wireless local area network (WLAN), a wireless personal area network (WPAN), a wireless wide area network (WWAN), or other network. In an embodiment, this network 136 may be operatively coupled to or include a peripheral device workspace cloud orchestrator 156 that includes one or more servers (e.g., peripheral device workspace cloud orchestrator server 158) or other computing devices that provide computer system resources as described herein that allow for the creation and maintenance of peripheral device workspaces, and orchestration of different node devices within one or more peripheral device workspaces. In embodiments described herein, the wireless interface device 128 with its radio 130, RF front end 132 and antenna 134 is used to communicate with the wireless peripheral devices via, for example, a Bluetooth® or Bluetooth® Low Energy (BLE) protocols. In an embodiment, the WAN, WWAN, LAN, and WLAN may each include an AP 138 or base station 140 used to operatively couple the information handling system 100 to a network 136. In a specific embodiment, the network 136 may include macro-cellular connections via one or more base stations 140 or a wireless AP 138 (e.g., Wi-Fi), or such as through licensed or unlicensed WWAN small cell base stations 140. Connectivity may be via wired or wireless connection. For example, wireless network wireless APs 138 or base stations 140 may be operatively connected to the information handling system 100. Wireless interface adapter 128 may include one or more radio frequency (RF) subsystems (e.g., radio 130) with transmitter/receiver circuitry, modem circuitry, one or more antenna radio frequency (RF) front end circuits 132, one or more wireless controller circuits, amplifiers, antennas 134 and other circuitry of the radio 130 such as one or more antenna ports used for wireless communications via multiple radio access technologies (RATs). The radio 130 may communicate with one or more wireless technology protocols.

In an embodiment, the wireless interface adapter 128 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, or similar wireless standards may be used. Wireless interface adapter 128 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums. The wireless interface adapter 128 can represent an add-in card, wireless network interface module that is integrated with a main board of the information handling system 100 or integrated with another wireless network interface capability, or any combination thereof.

In some embodiments, software, firmware, dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes instructions, parameters, and profiles 112 or receives and executes instructions, parameters, and profiles 112 responsive to a propagated signal, so that a hardware device connected to a network 136 may communicate voice, video, or data over the network 136. Further, the instructions 112 may be transmitted or received over the network 136 via the network interface device or wireless interface adapter 128. It is appreciated that any computing device including the cloud orchestrator server 158, the cloud orchestrator console 160, and the information handling system 100 may include a computer-readable medium that includes instructions, parameters, and profiles 112.

The information handling system 100 may include a set of instructions 112 that may be executed to cause the computer system to perform any one or more of the methods or computer-based functions disclosed herein. For example, instructions 112 may be executed by a hardware processor 102, GPU 103, EC 104 or any other hardware processing resource and may include software agents, or other aspects or components used to execute the methods and systems described herein. Various software modules comprising application instructions 112 may be coordinated by an OS 116, and/or via an application programming interface (API). An example OS 116 may include Windows®, Android®, and other OS types. Example APIs may include Win 32, Core Java API, or Android APIs.

In an embodiment, the information handling system 100 may include a disk drive unit 120. The disk drive unit 120 and may include machine-readable code instructions, parameters, and profiles 112 in which one or more sets of machine-readable code instructions, parameters, and profiles 112 such as firmware or software can be embedded to be executed by the hardware processor 102 or other hardware processing devices such as a GPU 103 or EC 104, or other microcontroller unit to perform the processes described herein. Similarly, main memory 106 and static memory 108 may also contain a computer-readable medium for storage of one or more sets of machine-readable code instructions, parameters, or profiles 112 described herein. The disk drive unit 120 or static memory 108 also contain space for data storage. Further, the machine-readable code instructions, parameters, and profiles 112 may embody one or more of the methods as described herein. In a particular embodiment, the machine-readable code instructions, parameters, and profiles 112 may reside completely, or at least partially, within the main memory 106, the static memory 108, and/or within the disk drive 120 during execution by the hardware processor 102, EC 104, or GPU 103 of information handling system 100.

Main memory 106 or other memory of the embodiments described herein may contain computer-readable medium (not shown), such as RAM in an example embodiment. An example of main memory 106 includes random access memory (RAM) such as static RAM (SRAM), dynamic RAM (DRAM), non-volatile RAM (NV-RAM), or the like, read only memory (ROM), another type of memory, or a combination thereof. Static memory 108 may contain computer-readable medium (not shown), such as NOR or NAND flash memory in some example embodiments. The applications and associated APIs, for example, may be stored in static memory 108 or on the disk drive unit 120 that may include access to a machine-readable code instructions, parameters, and profiles 112 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 122 (a.k.a. a power supply unit (PSU)). The PMU 122 may include a hardware controller and executable machine-readable code instructions to manage the power provided to the components of the information handling system 100 such as the hardware processor 102 and other hardware components described herein. The PMU 122 may control power to one or more components including the one or more drive units 120, the hardware processor 102 (e.g., CPU), the EC 104, the GPU 103, a video/graphic display device 144, or other wired I/O devices 142 such as the mouse 152, the stylus 148, a keyboard 146, and a trackpad 150 and other components that may require power when a power button has been actuated by a user. In an embodiment, the PMU 122 may monitor power levels and be electrically coupled to the information handling system 100 to provide this power. The PMU 122 may be coupled to the bus 118 to provide or receive data or machine-readable code instructions. The PMU 122 may regulate power from a power source such as the battery 124 or AC power adapter 126. In an embodiment, the battery 124 may be charged via the AC power adapter 126 and provide power to the components of the information handling system 100, via wired connections as applicable, or when AC power from the AC power adapter 126 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 110 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 is operatively coupled to a peripheral device workspace cloud orchestrator 156 that includes any number of software modules or systems described herein executing on one or more servers, computing devices, and other cloud computing resources such as the peripheral device workspace cloud orchestrator server 158. The peripheral device cloud orchestrator 156 may, therefore, include software or firmware modules executing on any hardware processing resources that may be distributed over multiple physical locations but act in concert with each other and specifically the peripheral device workspace cloud orchestrator server 158 to facilitate maintenance and implementation of peripheral device operational configuration policies for a plurality of peripheral device workspaces for an enterprise to manage a fleet of peripheral device across many enterprise locations or locations outside the enterprise. The one or more node devices at an identified location (e.g., including the information handling system 100 as an anchor node device, and one or more peripheral device nodes such as I/O devices 142) form part of each peripheral device workspace. The execution of code instructions of the peripheral device workspace cloud orchestrator 156 at one or more peripheral device workspace cloud orchestrator servers 158 create or adjust peripheral device operational configuration policies based on the registered node devices detected within the one or more created peripheral device workspaces, and apply the peripheral device operational configuration policies to the created peripheral device workspace(s). It is appreciated that the node devices described herein may include each of the peripheral devices operatively coupled to the information handling system 100 acting as a primary or anchor node device and the workspaces created may be described as a peripheral device workspace.

The peripheral device workspace cloud orchestrator server 158 may be any computing device that may include similar elements as the information handling system 100 such as a memory device, a cloud orchestrator hardware processing device 170, a PMU, and other elements that allow the peripheral device workspace cloud orchestrator server 158 to execute code instructions of the cloud manageability orchestrator module 166, ecosystem manageability service module 168, workspace capability informed peripheral device purchase recommendation system 169, and other software as described herein. In an embodiment, the peripheral device workspace cloud orchestrator server 158 may be operatively coupled to any information handling system to display a peripheral device workspace cloud orchestrator console 160 graphical user interface. The peripheral device workspace cloud orchestrator console 160 graphical user interface may be used by the ITDM in some embodiments to create and propagate peripheral device operational configuration policies, or to manage dynamic peripheral device workspace sessions (e.g., associate a user's identification with a peripheral device workspace with a user composite peripheral device workspace identifier). It is appreciated that the peripheral device workspace cloud orchestrator console 160 graphical user interface may be interfaced with by a cloud orchestrator input device 162 and a cloud orchestrator video display device 164 that allows the ITDM to complete these processes and engage with the peripheral device workspace cloud orchestrator server 158 in an embodiment.

As described herein, the peripheral device workspace cloud orchestrator server 158 includes a computer-readable program code of a peripheral device workspace cloud manageability orchestrator module 166 that, when executed by the cloud orchestrator hardware processing device 170 of the peripheral device workspace cloud orchestrator server 158, defines and stores in a database peripheral device workspaces with a peripheral device workspace identification value at locations, and manages creation and adjustment of peripheral device operational configuration policies for one or more node devices. In the context of embodiments of the present specification and in the appended claims, a peripheral device workspace may be an ecosystem of node devices (e.g., including peripheral devices coupled to the information handling system 100, a docking station 151, etc.) connected to a primary or anchor node device such as the information handling system 100. In an embodiment, a peripheral device workspace may also be defined with a peripheral device workspace identification value and be part of a user composite peripheral device workspace identifier for a user in a database and associated with each of the information handling system 100 and peripheral devices (e.g., input/output devices 142) such that a user may have multiple peripheral device workspaces having peripheral device workspace identification values that are associated with the user based on the context and/or environment of each identified peripheral device workspace. For example, a user composite peripheral device workspace identifier may be used to define a first peripheral device workspace at a home office having a first peripheral device workspace identification value, a second peripheral device workspace at a work office having a second peripheral device workspace identification value, a third peripheral device workspace at a different location (e.g., a coffee shop) having a third peripheral device workspace identification value, and other peripheral device workspaces that can be defined by both the node devices included within the peripheral device workspace and the location of the peripheral device workspace (e.g., defined by location data such as GPS data, network data, or other data to link to a physical location) and having a having a peripheral device workspace identification value.

In an embodiment, the execution of computer-readable program code of the peripheral device workspace cloud manageability orchestrator module 166 causes the peripheral device workspace cloud orchestrator server 158 to receive, create, or adjust peripheral device operational configuration policies based on the registered node devices detected within the one or more created peripheral device workspaces having peripheral device workspace identification values. In some embodiments, the peripheral device operational configuration policies may be received from the peripheral device workspace cloud orchestrator console 160 as initiated by the ITDM. The ITDM may be any information technology decision maker that may decide the peripheral device operational configuration policies to be associated with peripheral device workspaces formed at the peripheral device workspace cloud orchestrator server 158 and having peripheral device workspace identification values. For example, the ITDM may decide which settings for each of the node devices, including the primary or anchor node device, is an optimal and desired setting to be used. In such an example embodiment, the ITDM may create these peripheral device operational configuration policies and desired settings at the peripheral device workspace cloud orchestrator console 160 graphical user interface for capabilities of particular peripheral devices. In other example embodiments, these settings may be set by the peripheral device workspace cloud manageability orchestrator module 166 automatically to a default configuration determined based on identified capabilities of a given peripheral device or set to operational configurations automatically by virtue of matching capabilities of a given peripheral device with corresponding capabilities of other nodes in a peripheral device workspace. In various embodiments herein, the peripheral device workspace cloud orchestrator server 158 may propagate these peripheral device operational configuration policies from the peripheral device workspace cloud orchestrator server 158 executing the peripheral device workspace cloud manageability orchestrator module 166 to one or more device nodes in a peripheral device workspace. Upon receipt of these peripheral device operational configuration policies at the peripheral device workspace cloud orchestrator server 158 from the peripheral device workspace cloud manageability orchestrator module 166, the execution of the peripheral device workspace cloud manageability orchestrator module 166 may propagate these peripheral device operational configuration policies to each of the device nodes within the created peripheral device workspace.

In an embodiment, the peripheral device workspace cloud orchestrator server 158 may also execute computer readable program code of an ecosystem manageability service module 168. Execution of the ecosystem manageability service module 168 applies the peripheral device operational configuration policies to the created peripheral device workspace. In an embodiment, the peripheral device workspace cloud manageability orchestrator module 166 creates or adjusts peripheral device operational configuration policies for each of the one or more node devices 142 within the peripheral device workspace. As described herein, the ecosystem manageability service module 168 may identify those peripheral device nodes 142 that form part of the peripheral device workspace having a peripheral device workspace identifier value and may propagate those peripheral device operational configuration policies that apply to those peripheral device nodes 142. For example, where a plurality of peripheral device workspaces with a plurality of peripheral device workspace identifier values each include a specific wireless mouse for which a peripheral device operational configuration policy has been created or updated, the execution of the computer-readable program code of the ecosystem manageability service module 168 causes the peripheral device workspace cloud orchestrator server 158 to send those peripheral device operational configuration policies to the appropriate peripheral device workspace (e.g., to each of the primary or anchor node devices 100) so that those peripheral device operational configuration policies may be passed to the wireless mice in each peripheral device workspace having a peripheral device workspace identifier value where such as specific mouse model or type is located.

A node device database may be included in a peripheral device workspace management system database 167 or be its own database (not shown) operatively coupled to the peripheral device workspace cloud orchestrator server 158 may provide the peripheral device workspace cloud orchestrator server 158 with details regarding the node devices detected and forming the peripheral device workspaces and associated particular peripheral device workspace identification values described herein. For example, the peripheral device workspace management system database 167 may include data regarding the possible settings for any given node device 142, compatibility of these node devices of 142 with other node devices of 142 within any given peripheral device workspace, and capabilities of the node devices 142 among other characteristics and features of the node devices. Each peripheral device 142 may be associated with an orchestrated device descriptor (ODD) in the peripheral device workspace management system database 167 which includes a description of all non-configurable aspects of the peripheral device 142, such as the type of port connection(s) required for operative coupling with a peripheral device workspace anchor node information handling system 130 and power delivery requirements via those connections, if any. The orchestrated device descriptor may also identify the configurable capabilities of such a device 142.

An information handling system 100 that is operatively connected to one or more peripheral devices 142 in an embodiment may operate as an anchor node for the peripheral device workspace in that it gathers capabilities and peripheral device operational and environmental context telemetry readings about all of the peripheral devices 142, within a given peripheral device workspace, as described directly below, communicates that peripheral device operational and environmental context telemetry readings to the cloud manageability orchestrator module 166, receives peripheral device operational configuration policies describing how to configure the peripheral devices 142, and the anchor node information handling system 100 itself, and implements peripheral device operational configuration policies.

A user of the information handling system 100 may visit an online product purchase platform for purchase of a new peripheral device for incorporation within an existing peripheral device workspace associated with that user's user composite peripheral device workspace identifier. The product purchase platform may work in tandem with execution of code instructions for the workspace capability informed peripheral device purchase recommendation system 169 at the peripheral device workspace cloud orchestrator server 158 to prompt the user to log in using to associate the user with her user composite peripheral device workspace identifier, and to identify one of a plurality of the peripheral device workspaces associated with that user composite peripheral device workspace identifier into which the user plans to incorporate the peripheral device being purchased. Code instructions of a workspace capability informed peripheral device purchase recommendation system 169 operating at the peripheral device workspace cloud orchestrator server 158 may then execute to retrieve a peripheral device workspace anchor node status update document associated with that user-selected peripheral device workspace from the peripheral device workspace management system database 167.

The retrieved peripheral device workspace anchor node status update document stored at the peripheral device workspace management system database 167 may include a current status for the connectivity between the anchor node information handling system 100 and one or more peripheral devices 142 within the user-identified peripheral device workspace, as described in greater detail below. This may include, for example, a description of a number and type of available and currently functioning ports for potential connection to the peripheral device being purchased and the peripheral devices 142 within the already established peripheral device workspace to which the user wishes to add the newly purchased peripheral device. Each peripheral device available for purchase at the product purchase platform may also be associated with an orchestrated device descriptor (ODD) which includes a description of all non-configurable aspects of the peripheral device available for purchase, such as the type of port connection(s) required for operative coupling with a peripheral device workspace anchor node information handling system 100 and power delivery requirements via those connections, if any. The orchestrated device descriptor may also identify the configurable capabilities of such a device and may be accessible by the product purchase platform.

Execution of code instructions for an ecosystem manageability sub-agent 172 on a user information handling system 100 monitors for sets of peripheral device operational telemetry readings of a peripheral device workspace, such as time, applications currently executing or planned, hardware component usage metrics, connection type (e.g., wireless, wired, wireless wide area network (WWAN), wireless local area network (WLAN), wireless private area network (WPAN)), security credentials for the user, or environmental sensor readings (e.g., humidity, temperature, ambient light), among other possible peripheral device operational and environmental context telemetry readings for the information handling system node 100 and peripheral device nodes 142 in a peripheral device workspace. These peripheral device operational telemetry readings associated with a peripheral device workspace identification value may be gathered routinely in telemetry measurements, or upon each startup of an anchor information handling system 100, for example. The ecosystem manageability sub-agent 172 executing at the information handling system 100 in a peripheral device workspace may create a manifest of peripheral device nodes 142 and other nodes for a peripheral device workspace identification value to represent the current peripheral device workspace, including an identification of a location, identification of the user, and an identification (e.g., by product serial number or other peripheral device identification) of each of the peripheral device nodes 142 connected to or operably coupled to the anchor information handling system 100 at a peripheral device workspace. Identification of the each of the peripheral device nodes 142 may include or be associated with an ODD in various embodiments herein.

The hardware processor 102 of the user anchor information handling system 100 may execute code instructions of the ecosystem manageability sub-agent 172 to also collect one or more peripheral device operational telemetry readings (e.g., time, applications executing, hardware component usage metrics, or other telemetry data indicating usage patterns for the information handling system 100 or various peripheral devices 142 in a peripheral device workspace). The manifest of peripheral device nodes and other nodes as well as location of a peripheral device workspace described above may be combined with the peripheral device operational telemetry readings for the peripheral device workspace and an identification of the anchor node information handling system 100 user into a peripheral device workspace anchor node status update document written in a machine-readable language or machine markup language such as JavaScript Object Notation (JSON), for example, and to be associated with a peripheral device workspace identification value. The peripheral device workspace anchor node status update document may be transmitted for storage with the peripheral device workspace identification value at a peripheral device workspace management system database 167 operating with the peripheral device workspace cloud orchestrator server 158. Each time a peripheral device configuration setting is changed by the user, a new peripheral device is added to the peripheral device workspace, or changes to environmental context data for the peripheral device workspace are detected, a new peripheral device workspace anchor node status update document including this updated configuration may be transmitted to the peripheral device workspace cloud orchestrator 156 executing on the peripheral device workspace cloud orchestrator server 158.

The peripheral device workspace management system database 167 may further store a user composite peripheral device workspace identifier that is unique to individual users of one or more defined peripheral device workspaces that are associated with identification of the user of the user's information handling system 100 and peripheral device workspace identification values of the peripheral device workspaces used by that user. Thus, a user composite peripheral device workspace identifier may identify a single user of an anchor node information handling system 100, and a peripheral device workspace identification value for each of one or more peripheral device workspaces in which the user's information handling system 100 operates as an anchor node at various times. The user composite peripheral device workspace identifier may thus be user-specific and user-centric. The peripheral device workspace identification value, in comparison, may define a location and list of peripheral device nodes 142, and may thus be peripheral device workspace-centric.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

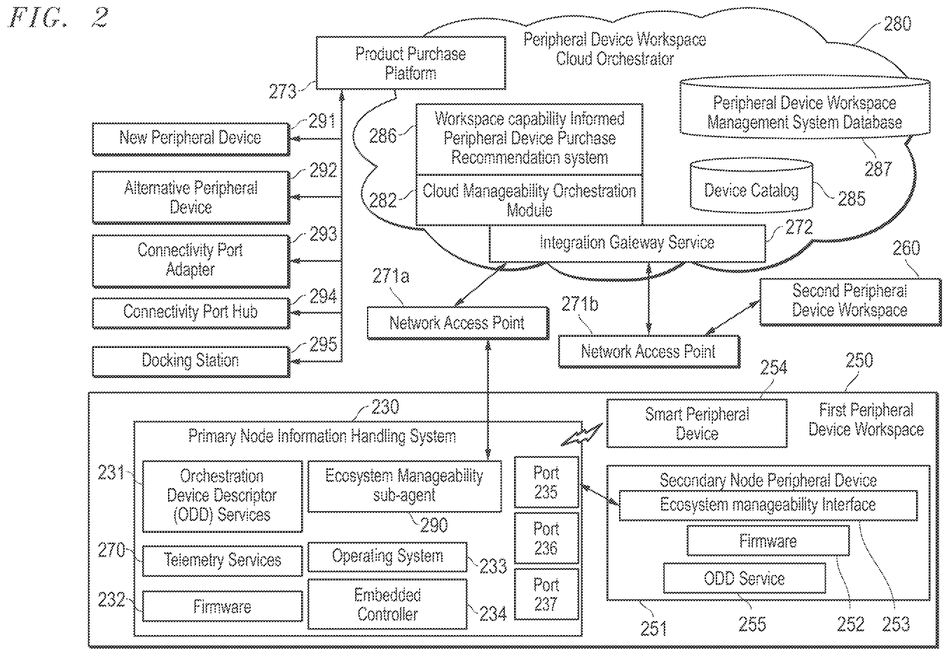

FIG. 2 is a block diagram illustrating a cloud-based peripheral device workspace cloud orchestrator executing on one or more peripheral device workspace cloud orchestrator servers for defining a first of a plurality of peripheral device workspaces in which a user information handling system operatively couples with a first plurality of peripheral devices according to an embodiment of the present disclosure. As described previously, a user may oftentimes use an information handling system 230 in a peripheral device workspace 250. In this context, a peripheral device workspace 250 or 260 can be viewed as an environment with a location identifier that includes the user information handling system 230 (e.g., a laptop) operating as a primary or anchor node for the peripheral device workspace 250 and peripheral devices 251 and 254 operating as secondary nodes of the peripheral device workspace 250 that are connected to the user information handling system 230. An environmental context may include, for example, location, time of day, applications being executed, wireless or wired connection capabilities, or security credentials for the user. Peripheral devices 251 and 254 may commonly include internal or external devices such as displays, a keyboard, a mouse, a webcam, a printer, a speaker, a fingerprint scanner, etc. According to various embodiments herein, a peripheral device workspace 250 or 260 may include a wired or wireless dock by which the user information handling system 230 connects to some or all the peripheral devices including smart peripheral devices such as 254 having some compute or input/output capabilities. Peripheral device 254 in an example embodiment may considered a “smart” peripheral device because it may operate an agent or firmware, and include a network interface device or wireless receiver that makes the smart peripheral device 254 capable of direct communication with the cloud-based peripheral device workspace cloud orchestrator 280 via the integration gateway services 272 and the network access point 271 for some subset of secondary nodes. Similarly, a primary or anchor node information handling system 230 is also capable of direct communication with the cloud-based peripheral device workspace cloud orchestrator 280 code instructions executing on a peripheral device workspace cloud orchestrator server via the integration gateway services 272 and the network access point 271 for some or all secondary nodes in the peripheral device workspace 250 or 260.

These peripheral devices such as 251 and 254 within a given peripheral device workspace such as 250 or 260 may operatively couple to a user's anchor node information handling system 230 within the peripheral device workspace 250 or 260 via various types of ports 235, 236, or 237, hubs, adapters, or docking stations. For example, peripheral devices 251 or 254 may connect to a peripheral device workspace anchor node information handling system 230 via Universal Serial Bus (USB) standardized ports 235, 236 or 237, such as USB-A, USB 2.0, USB 3.0, or USB-C, or via other standardized ports, such as High Definition Multi-Media Interface (HDMI), DisplayPort (DP), Mini-DP, or audio in/out. In addition, some of these port types may support the transfer of power via the port, such as USB-A, USB 2.0, USB 3.0, USB-C, or the USB power delivery (USB-PD) supplement to the USB-C standard, while others such as HDMI do not. In some cases, docking stations, hubs, or adapters may be used to increase the number of a certain type of port available to the user. Users routinely have a plurality of peripheral devices such as 251 and 254 plugged into these ports 235, 236, or 237, docking stations, hubs, or adapters, leaving only one or a few available for further connection to other peripheral devices such as 291 or 292 available for purchase via the product purchase platform 273. In addition, one or more of these ports 235, 236, or 237 may be disabled or non-functional at a given time.

A system is needed to inform the user's or ITDM's decision of which new peripheral devices to purchase, via the product purchase platform 273, based on the availability of ports 235, 236, or 237, and power supply from the information handling system 230 when it is acting as the anchor node of the peripheral device workspace 250 or 260 in which the user plans to incorporate the newly purchased peripheral device, such as 291, 292, 293, 294, or 295. A user or ITDM may utilize or manage a plurality of peripheral device workspaces having many peripheral devices under management. It would be a substantial burden for a user or ITDM to track an anchor information handling system node 230 that may travel to or be utilized within any of a plurality of peripheral device workspaces in an enterprise to determine what connectivity, power sources, and compatibility are available at any given peripheral device workspace. Embodiments of the present disclosure are directed to a particularized system of code instructions for a workspace capability informed peripheral device purchase recommendation system 286 executing on a peripheral device workspace cloud orchestrator server to identify a peripheral device workspace 250 intended for a new peripheral device node 291, access peripheral device workspace capabilities of nodes including the anchor information handling system node at the peripheral device workspace 250 from peripheral device workspace management system database 287, and interface with remote software code instructions executing a product purchase platform during selection of a new peripheral device node 291 for purchase. Without such a system, a user may purchase a peripheral device such as 291 only to determine it is incompatible with the capabilities of the user's current peripheral device workspace 250 or 260, which may require return of the purchased peripheral device 291, or purchase of additional hubs 294, adapters 293, or docking stations 295 before the user can effectively use the newly purchased peripheral device 291. Execution of code instructions for the workspace capability informed peripheral device purchase recommendation system 286 in an embodiment may address these issues by accessing data for potential available new peripheral device nodes 291 available for purchase and recommending the purchase of only peripheral devices the user's peripheral device workspace 250 or 260 are capable of connecting to and powering.

A peripheral device workspace 250 or 260 may oftentimes be used for hybrid work scenarios. For example, a business may have an office space that includes hoteling cubes that can be assigned to, reserved by, or otherwise utilized by the business's employees as peripheral device workspaces 250 or 260. In such cases, the business may allow its employees to connect their laptops (e.g., 230) to a dock (e.g., 254) in a particular hoteling cube where various peripherals (e.g., 251) may be available for use. A business may also have a collaborative peripheral device workspace 250 or 260 that may be a conference room or meeting room where plural users with plural primary node information handling systems 230 utilize some or all peripheral device nodes in that peripheral device workspace at the same time. Users may also employ peripheral device workspaces 250 or 260 when working from home or other locations.

When a user employs multiple peripheral device workspaces 250 or 260 (e.g., by connecting a laptop to different combinations of peripheral devices during a workday), it can be tedious for the user to configure the peripheral device workspaces 250 or 260 to his or her preferences. For example, while using one peripheral device workspace 250, the user may set configurations for the peripheral devices 251 and 254 of the peripheral device workspace 250 to match the user's preferences or they may be configured to meet an operating policy set by an ITDM for a given peripheral device workspace. If the user switches to a different peripheral device workspace 260, those configurations may not be consistent with the peripheral devices (not shown) of the different peripheral device workspace 260 or may result in unintended changes. The user may therefore have to manually reconfigure the peripheral devices (not shown) within the peripheral device workspace 260.

Execution of code instructions for an ecosystem manageability sub-agent 290 on a user information handling system 230 monitor telemetry readings taken by a telemetry service 270 for environmental context data of a peripheral device workspace, such as time, location, applications currently executing or planned, connection type (e.g., wireless, wired, wireless wide area network (WWAN), wireless local area network (WLAN), wireless private area network (WPAN)), security credentials for the user, or environmental sensor readings (e.g., humidity, temperature, ambient light), functionality and power/connectivity capabilities for various ports 235, 236, and 237, among other possible telemetry readings for the information handling system 230. These telemetry measurements may be gathered routinely, or upon each startup of an information handling system 230, for example.

In addition, the peripheral device workspace cloud orchestrator 280 may gather information regarding the range of capabilities for each peripheral device (e.g., 251 and 254). Each peripheral device, such as 251 may include a range of capabilities, and the user may choose to configure the peripheral device 251 to operate according to a selected setting or configuration within this range of capabilities. For example, a range of capabilities may include available wired or wireless connectivity options to configure a peripheral device 251 or 254. In an example embodiment, a peripheral device node may have an plurality of wired connectivity options for a display device including an USB wired plug, an HDMI wired plug, a display port wired plug, and one or more wireless connectivity options that may be set based on operative coupling to an anchor information handing system in a peripheral device workspace 250. Other capabilities may include connectivity capabilities for a peripheral device 251, such as types of wired connectors or wireless protocols available configuration may include selection of connectivity type as well as speeds or bandwidths available.

In another example, in an embodiment in which the peripheral device 251 is an external display device, the peripheral device 251 may be capable of operating within a range of functional capabilities defining the display resolution, such as between a resolution of 640×480 pixels, which may be the lowest resolution supported by the operating system 233, and 3840×2160 pixels, which is the standard resolution for 4K Ultra-High Definition (4K UHD) monitors. Thus, the functional capabilities for the peripheral device 251 in such an example may be the entire range between 640×480 pixels and 3840×2160 pixels. The user may select an adjustable operational configuration for the peripheral device 251 by choosing one available resolution within this range of 620×480 pixels and 3840×2160 pixels. This may be done by the user, for example, through a “preferences,” “properties,” or “settings” user interface within the operating system 233. In some cases, the peripheral device 251 may be preset with a default configuration. These default configurations may also be considered adjustable operational configurations herein, in that the user has the opportunity to adjust such a default configuration through the “preferences,” “properties,” or “settings” user interface within the operating system 233. In such a way, the peripheral device 251 may be configured according to a user-selectable, adjustable operational configuration that lies within a range of functional capabilities for the peripheral device.

In some embodiments, the information defining the range of functional capabilities for the peripheral device 251 may be stored at the peripheral device 251, within the firmware 253. In other embodiments, the range of functional capabilities for the peripheral device 251 may be stored at an orchestration device descriptor (ODD) service. In an embodiment, the ODD service 255 for the peripheral device 251 may also store static or non-adjustable features for the peripheral device 251, such as locations for various ports, physical dimensions of the new peripheral device 251, or physical locations for internal components such as an embedded camera. Model number, device number, serial number media access control (MAC) address, or other identifying information for the peripheral device 251 may also be stored within the ODD service 255 with an ODD for a peripheral device 251, or within firmware 253. The ODD for existing peripheral devices 251 or 254 includes not only a description of all non-configurable aspects of the peripheral device, as well as the configurable capabilities of such a device, a unique peripheral device identifier such as a serial number, and a peripheral device type classification (e.g., mouse, display, keyboard, webcam, etc.) may be included in the ODD.

Static or non-adjustable features for the peripheral devices 291, 292, 293, 294, or 295 available for purchase via the product purchase platform 273 in an embodiment, such as types and locations for various ports, power and connectivity requirements for such ports, physical dimensions of the new peripheral device 251, or physical locations for internal components such as an embedded camera may be stored within the device catalog 285. This may be accessed by execution of the workspace capability informed peripheral device purchase recommendation system 286 at the peripheral device workspace cloud orchestrator server from a communication link with the product purchase platform 273 executing at servers of a vendor or manufacturer. Model number, device number, serial number media access control (MAC) address, or other identifying information for the peripheral devices 291, 292, 293, 294, or 295 available for purchase may also be stored within the device catalog 285 with an ODD for peripheral devices 291, 292, 293, 294, or 295 available for purchase. The ODD for peripheral devices 291, 292, 293, 294, or 295 available for purchase includes not only a description of all non-configurable aspects of the peripheral device, as well as the configurable capabilities of such a device, a unique peripheral device identifier such as a serial number, and a peripheral device type classification (e.g., mouse, display, keyboard, webcam, etc.) may be included in the ODD.

The ecosystem manageability sub-agent 290 of the anchor node information handling system 230 in an embodiment may retrieve the functional capabilities for the peripheral device 251 from the firmware 253 or from the ODD service 255 via communication with the ecosystem manageability interface 252, which may act as an application programming interface (API), for example, between the firmware 253 and the ecosystem manageability sub-agent 290. The ecosystem manageability sub-agent 290 in an embodiment may gather this information from the various seamless workspace ecosystem maintenance interfaces 252, for example, upon each detection of operative coupling of the peripheral devices 251 and 254, respectively, with the anchor node information handling system 230, or upon an initial pairing. In an embodiment, the ecosystem manageability sub-agent 290 in an embodiment may transmit the gathered functional capabilities, including connectivity and power sources used, for the peripheral device 251, or 254 to the peripheral device workspace cloud orchestrator 280, via the network access point 271a and the integration gateway service 272.

The anchor node information handling system 230 in an embodiment may also include a hardware processor or embedded controller 234 executing code instructions of the ecosystem manageability sub-agent 290. The anchor information handling system node 230 in an example embodiment may be operatively coupled to a secondary node peripheral device 251, which may further include a microcontroller executing code instructions of an ecosystem manageability interface 252 and firmware 253. The ecosystem manageability 252 in an embodiment may facilitate communication between the ecosystem manageability sub-agent 290 and the firmware 253 for the secondary node peripheral device 251. Although not shown in FIG. 2, the smart peripheral device 254 may further include internal components facilitating communication of telemetry measurements for the peripheral device 254 to the ecosystem manageability sub-agent 290.

The ecosystem manageability sub-agent 290 in an embodiment may gather, via ecosystem manageability interface 252, various peripheral device operational telemetry data readings describing adjustable configurations for the secondary node peripheral device 251 within the peripheral device workspace 250. For example, in an embodiment in which the peripheral device 251 is an external display device, the ecosystem manageability sub-agent 290 may gather telemetry information including a current adjustable operational configuration at the peripheral device 251 for display resolution, display refresh rate, brightness, contrast, color gamut, horizontal view angle, vertical view angle, and response time. Other types of peripheral devices 251 are also contemplated and may include relevant current adjustable operational configuration telemetry data as environmental context data for any peripheral device types as described herein. Relevant current adjustable operational configuration telemetry data may include wired or wireless connectivity among nodes in the peripheral device workspace and connectivity conditions and power source availability for peripheral device nodes in the peripheral device workspace 250 or 260. A similar method of gathering telemetry for a smart peripheral device 254 may also be performed via the ecosystem manageability sub-agent 290 in an embodiment.

The ecosystem manageability sub-agent 290 executing at the information handling system 230 may create a manifest listing each of the peripheral device nodes 251 and 254 within the peripheral device workspace 250, as well as the anchor information handling system node 230. The manifest of peripheral device nodes 251 and 254 and other nodes 230 as well as location of a peripheral device workspace 250 may be combined with the peripheral device operational telemetry readings for the peripheral device workspace 250 for capabilities and configuration settings and an identification of the anchor node information handling system 230 user into a peripheral device workspace anchor node status update document written in a machine-readable language or machine markup language such as JavaScript Object Notation (JSON), for example, for the peripheral device workspace. The peripheral device workspace anchor node status update document is transmitted for storage with the peripheral device workspace identification value at a peripheral device workspace management system database operating in the peripheral device workspace cloud orchestrator 280. Each time a peripheral device configuration setting is changed by the user, a new peripheral device is added to the peripheral device workspace 250, or changes to environmental context data for the peripheral device workspace 250 are detected, a new peripheral device workspace 250 anchor node status update document including this updated configuration may be transmitted to the peripheral device workspace cloud orchestrator 280.

The anchor node information handling system 230 in an embodiment may be operatively connected to the internet via a network access point (AP) 271a, which may further connect to one or more cloud-based applications, servers, or systems. Such cloud-based applications in an embodiment may include a peripheral device workspace cloud orchestrator 280 which communicates with the remote anchor node information handling system 230 in various peripheral device workspaces 250 and 260, respectively, via an integration gateway service 272. The integration gateway service 272 in an embodiment may operate as an Application Programming Interface (API) or a Query Language (QL) supervisor to control communications to and from the peripheral device workspace cloud orchestrator 280 and its modules and systems executing on the one or more peripheral device workspace cloud orchestrator servers, for example. More specifically, the integration gateway service 272 may, via an API, control the query language in which queries are made to the peripheral device workspace cloud orchestrator 280 or its software modules and systems executing at the peripheral device workspace cloud orchestrator server. As another example, the integration gateway service 272 may use a query language supervisor, such as GraphQL® to control such queries and the format in which results are provided by the peripheral device workspace cloud orchestrator 280. The anchor information handling system node 230 may communicate gathered peripheral device telemetry, as well as telemetry specific to the anchor information handling system node 230 itself, to the peripheral device workspace cloud orchestrator 280 via this integration gateway service 271a.

Various peripheral device workspaces (e.g., 250 and 260) such as the hybrid work office peripheral device workspaces, collaborative peripheral device workspaces, and other peripheral device workspaces described herein may be defined by location indicator detected for an anchor node information handling system 230 operating at the peripheral device workspace 250, and a manifest of nodes of peripheral devices 251 and smart devices 254 that may operate in the peripheral device workspace 250. Each such defined peripheral device workspace 250 or 260 may also be assigned a peripheral device workspace identification value which may be stored and associated with stored manifests of nodes 230, 251, and 254 operating in the peripheral device workspace 250. Additional peripheral device operational telemetry readings for the peripheral device workspace 250 may be stored within one or more peripheral device workspace anchor node status update documents as well as included in the definition of the peripheral device workspace and associated with its peripheral device workspace identification value defined at the peripheral device workspace cloud orchestrator 280 server database 287, including peripheral device capabilities, peripheral device connectivity details, current peripheral device configurations or settings, peripheral device setting or configuration options, current status of the peripheral devices 230, 251, and 254, within the peripheral device workspace 250, and other features of nodes 230, 251, and 254 within the peripheral device workspace 250. For example, the definition of the peripheral device workspace 250 associated with a specific peripheral device workspace identification value may include a set of peripheral device operational telemetry readings and stored within one or more peripheral device workspace anchor node status update documents, such as time, applications currently executing or planned, connection type, functionality of various ports 235, 236, and 237, power delivery and connectivity capabilities for those ports 235, 236, and 237 (e.g., communication protocols by which peripheral devices 251 or 254 may be operatively coupled via the ports), hardware component capabilities or usage metrics, or environmental sensor readings (e.g., humidity, temperature), among other possible environmental context telemetry readings for an anchor node information handling system 230 operating within the defined peripheral device workspace 250.

A peripheral device workspace 250 may be defined by a location, a list of peripheral devices 251 and 254 operatively coupled to an anchor node information handling system 230 for a user, type of peripheral device workspace (e.g., personal, hoteling office/shared, or collaborative), and additionally in some cases, by one or more types of the environmental context data for the peripheral device workspace 250 described herein. Each of these defining factors may be associated in a database memory 287 operatively coupled to the peripheral device workspace cloud orchestrator server for the peripheral device workspace cloud orchestrator 280 with the peripheral device workspace identification value, which may also be associated with one or more peripheral device operational configuration policies describing how the nodes 230, 251 and 254 within the defined peripheral device workspace 250 are to operate. Thus, a particular peripheral device operational configuration policy for one or more peripheral device nodes 251 or 254 within a given peripheral device workspace 250 having a peripheral device workspace identification value may apply only when certain peripheral device operational telemetry readings describing usage patterns for those peripheral device nodes 251 or 254 are detected. In such a way, the peripheral device operational configuration policy for a peripheral device such as 251 or 254 within a peripheral device workspace 250 may be defined or associated with particularly defined usage patterns for that peripheral device. For example, a peripheral device operational configuration policy may apply only when certain software applications are executing at the anchor node information handling system 230 defined within the peripheral device workspace 250, or when one or more hardware components' (e.g., graphics processing unit (GPU), central processing unit (CPU), memory) usage metrics or connectivity metrics meet a predefined threshold.

A database memory 287 for the peripheral device workspace cloud orchestrator 280 may further store a user composite peripheral device workspace identifier that is unique to individual users of one or more defined peripheral device workspaces 250 or 260 that are associated with identification of the user of the user's information handling system 230 and peripheral device workspace identification values of the peripheral device workspaces 250 or 260 used by that user. Thus, a user composite peripheral device workspace identifier may identify a single user of an anchor node information handling system 230, and a peripheral device workspace identification value for each of one or more peripheral device workspaces 250 or 260 in which the user's information handling system 230 operates as an anchor node at various times. The user composite peripheral device workspace identifier may thus be user-specific and user-centric. The peripheral device workspace identification value, in comparison, may define a location and list of peripheral device nodes, and may thus be peripheral device workspace-centric.

Peripheral devices within a given peripheral device workspace, such as 250 or 260 may operatively couple to a user's anchor node information handling system 230 within the peripheral device workspace 250 or 260 via various types of ports 236 or 237, adapters, hubs, or docking stations. For example, peripheral devices such as 251 and 254 may connect to a peripheral device workspace anchor node information handling system 230 via Universal Serial Bus (USB) standardized ports, such as USB-A, USB 2.0, or USB-C, or via other standardized ports, such as High Definition Multi-Media Interface (HDMI), DisplayPort (DP), Mini-DP, or audio in/out. In addition, some of these port types may support the transfer of at least 15 W power via the port 236 or 237, such as USB-C, while others such as USB-A or USB 2.0 do not. In some cases, docking stations, hubs, or adapters may be used to increase the number of a certain type of port available to the user. Users routinely have a plurality of peripheral devices such as 251 plugged into these ports such as 235, docking stations, hubs, or adapters, leaving only one or a few available ports, such as 236 and 237 for further connection to other peripheral devices. In addition, one or more of these ports, such as 237 may be disabled or non-functional at a given time.

A user or ITDM visiting an online product purchase platform 271 executing at a vendor or manufacturer server to conduct a purchase of a new peripheral device, such as 291, 292, 293, 294, or 295 for incorporation within an existing peripheral device workspace 250 in an embodiment may not be aware of the capabilities, availability, and functionality of such anchor node ports 235, 236, and 237 during such a purchase. This may allow a user or ITDM to purchase a peripheral device, such as 291, only to determine it is incompatible with the capabilities of the user's current peripheral device workspace 250, which may require return of the purchased peripheral device 291, or purchase of additional hubs 294, adapters 293, or docking stations 295 before the newly purchased peripheral device 291 can be effectively used. In one example embodiment, code instructions of the workspace capability informed peripheral device purchase recommendation system 286 at the peripheral device workspace cloud orchestrator server in an embodiment may be executed to communicatively couple to and work in tandem with the product purchase platform 273 to assess available peripheral devices 291, 292, 293, 294, 295 for purchase and filter the search results at the product purchase platform 273 for peripheral devices available to purchase according to a determined port availability and power capability limitation for the anchor information handling system node 230 and the peripheral device workspace 250 managed by the peripheral device workspace cloud orchestrator 280 into which the user or ITDM indicates an intention to incorporate the newly purchased peripheral device.

A peripheral device workspace anchor information handling system node 230 in an embodiment may generate and transmit to a cloud manageability orchestrator module 282 a peripheral device workspace primary node status update document. This may include a manifest of devices, peripheral device operational telemetry readings for the anchor information handling system node 230 and secondary node peripheral devices 251 and 254, and a user composite peripheral device workspace identifier for the user of the anchor information handling system node 230. As described herein, each time a peripheral device configuration setting is changed by the user, a new peripheral device, such as 291, 292, 293, 294, or 295 is added to the peripheral device workspace 250, or changes to environmental context data for the peripheral device workspace 250 are detected, a new peripheral device workspace 250 anchor node status update document including this updated configuration may be transmitted to the peripheral device workspace cloud orchestrator 280. The peripheral device workspace anchor node status update document is transmitted for storage with the peripheral device workspace identification value at the peripheral device workspace management system database 287 operating in the peripheral device workspace cloud orchestrator 280.

These peripheral device operational telemetry readings may include for example, time of day, applications being executed, wireless or wired connection capabilities of nodes, status or functionality of one or more ports 235, 236, or 237 of the anchor node user information handling system 230 for connection to peripheral devices 251, 254, or peripheral devices for purchase, such as 291, 292, 293, 294, or 295 within a peripheral device workspace 250, security credentials for the user, and other workspace data. More specifically, these peripheral device operational telemetry readings may indicate that port 235 is not available for operative connection with any newly purchase peripheral devices 291, 292, 293, 294, or 295 because it is already operatively coupled to secondary node 251. As another example, these peripheral device operational telemetry readings may indicate that ports 236 and 237 are available for operative coupling with a newly purchased peripheral device 291, 292, 293, 294, or 295, and may provide port connectivity capabilities describing the communication protocols under which such ports 236 and 237 may operatively couple, as well as power delivery capabilities for ports 236 or 237 upon such an operative coupling.

As also described herein, the ODD for existing anchor nodes and peripheral device nodes such as 230, 251, or 254 or the peripheral devices available for purchase, such as 291, 292, 293, 294, or 295 includes a description of all non-configurable aspects of the peripheral devices 230, 251, 254, 291, 292, 293, 294, or 295, such as connectivity requirements identifying one or more communication protocols or port types that can be used for operative coupling with the peripheral devices and power requirements for such an operative coupling. The ODD may also include the configurable capabilities of such a device, a unique peripheral device identifier such as a serial number, and a peripheral device type classification (e.g., mouse, display, keyboard, webcam, etc.). As described herein, each such registered user, such as the user of anchor information handling system node 230 may be associated with a user composite peripheral device workspace identifier, generated and maintained by the peripheral device workspace cloud orchestrator 280 and with data such as configuration settings stored for each of the nodes (e.g., 230, 251, and 254) of a peripheral device workspace (e.g., 250). This user composite peripheral device workspace identifier for each user may include an identification of a single user, the plurality of peripheral device workspaces 250 and 260 associated with that user, and the plurality of peripheral devices 251 and 254 that have been operatively coupled to the user's information handling system 230, as well as peripheral device operational and environmental context telemetry readings previously received by the peripheral device workspace cloud orchestrator 280 from the information handling system 230 or from smart peripheral devices such as 254.

In an embodiment, a user of or ITDM using a product purchase platform 273 and of an anchor information handling system node 230 for an existing peripheral device workspace 250 or 260 may supply a user authorization to link to a user composite peripheral device workspace identifier when logging into the product purchase platform 273. The user or ITDM may then browse for a new peripheral device 291 of a specific peripheral device type for purchase and incorporation within an existing peripheral device workspace 250 or 260. As described herein, the user composite peripheral device workspace identifier is unique to the individual user of the anchor information handling system node 230 for one or more defined peripheral device workspaces 250 or 260 that are associated with identification of the user or the user's information handling system and peripheral device workspace identification values of the peripheral device workspaces 250 or 260 used by that user. Thus, a user composite peripheral device workspace identifier may identify a single user of an anchor node information handling system, and a peripheral device workspace identification value for each of one or more peripheral device workspaces 250 or 260 in which the user's information handling system 230 operates as an anchor node at various times. The user composite peripheral device workspace identifier may thus be user-specific and user-centric. The peripheral device workspace identification value, in comparison, may define a location and list of peripheral device nodes such as 230, 251 and 254 for peripheral device workspace 250, and may thus be peripheral device workspace-centric.

A cloud manageability orchestrator module 282 in an embodiment may retrieve one or more identified peripheral device workspace identification values associated with the user composite peripheral device workspace identifier supplied by the browsing user or ITDM. As described herein, a user composite peripheral device workspace identifier may identify a single user of an anchor node information handling system, such as 230, and a peripheral device workspace identification value for each of one or more peripheral device workspaces 250 or 260 in which the user's information handling system 230 operates as an anchor node at various times. In such an example embodiment, the cloud manageability orchestrator module 282 may retrieve peripheral device workspace identification values for both the peripheral device workspace 250 and the peripheral device workspace 260, for both of which the user information handling system 230 has previously served as an anchor node. The cloud manageability orchestrator module 282 may perform this step in an embodiment in order to assist in identifying the peripheral device workspace 250 or 260 into which the user intends to incorporate the peripheral device intended for purchase via the product purchase platform 273. Only after such a determination is made may execution of the workspace capability informed peripheral device purchase recommendation system 286 assist the purchasing user in selecting products compatible with available and operational ports for the anchor information handling system node 230.

The product purchase platform 273 in an embodiment may receive an identification of the one or more peripheral device workspaces 250 or 260 from the workspace capability informed peripheral device purchase recommendation system 286 and the workspace capability informed peripheral device purchase recommendation system 286 or the product purchase platform 273 may execute to prompt the browsing user to identify one of these peripheral device workspaces 250 or 260 into which the user plans to incorporate the newly purchased peripheral device. The user may select either peripheral device workspace 250 or peripheral device workspace 260 for planned incorporation of the new peripheral device in an embodiment. For example, the user may plan to incorporate the new peripheral device into a home peripheral device workspace 260 or an office peripheral device workspace 250. In an embodiment, the user may select or indicate that the new peripheral device for purchase via the product purchase platform 273 will be incorporated within the peripheral device workspace 250 by response to the prompt from the workspace capability informed peripheral device purchase recommendation system 286, for example. Then the workspace capability informed peripheral device purchase recommendation system 286 may conduct a search of the product purchase platform automatically to determine candidate available peripheral device nodes for purchase recommendation.

Each of these peripheral device workspaces 250 or 260 may include a different set of existing peripheral devices, such as 251 and 254 for peripheral device workspace 250, to which the user's information handling system 230 is operatively coupled when it operates within those peripheral device workspaces 250 or 260. The ways in which such existing peripheral devices operatively couple with the anchor information handling system node 230 may vary between the two peripheral device workspaces 250 or 260. For example, when the user information handling system 230 operates within the peripheral device workspace 250, it may operatively couple to the smart peripheral device 254 via a wireless link, and to the secondary peripheral device node 251 via a wired connection through port 235, leaving ports 236 and 237 available for further wired connection to other peripheral devices, such as the peripheral device the user is interested in purchasing. In contrast, when operating in the peripheral device workspace 260, the anchor information handling system node 230 in one example embodiment may operatively couple with any existing peripheral devices within that workspace using only wireless links, leaving each of ports 235, 236, and 237 available for connection to other peripheral devices. In another example embodiment, when operating in the peripheral device workspace 260, the anchor information handling system node 230 may use both ports 235 and 236 for wired operative coupling with existing peripheral devices, leaving only port 237 available for operative coupling with other peripheral devices. Thus, in order to recommend purchase of products having power and connectivity requirements that can be met by available and operative ports at the anchor information handling system node 230, execution of code instructions for the workspace capability informed peripheral device purchase recommendation system 286 must first determine which peripheral device workspace 250 or 260 into which the user or ITDM identifies as intended for incorporating the newly purchased peripheral device.

The cloud manageability orchestration module 282 in an embodiment may retrieve a recently received peripheral device workspace anchor node status update document from the peripheral device workspace management system database 287 for the user identified peripheral device workspace 250. As described herein, the peripheral device workspace anchor node status update document may include one or more peripheral device operational telemetry readings (e.g., time, applications executing, status or functionality of one or more ports of the anchor node user information handling system for connection to peripheral devices within a peripheral device workspace, or other telemetry data indicating usage patterns for the information handling system in a peripheral device workspace), and one or more peripheral device configuration settings (e.g., resolution for an external display device) for the operably coupled peripheral devices. These peripheral device operational telemetry readings may indicate which of the ports 235, 236, or 237 at the anchor information handling system node 230 are operatively coupled to other peripheral devices, such as 235 connected to peripheral device 251, and which are available for connection to other peripheral devices, such as any selected for purchase via the product purchase platform 273. The functionality of each of the ports 235, 236, or 237, identifying the ports 235, 236, or 237 as either functional or disabled or broken may also be included within the peripheral device operational telemetry readings.

In an embodiment, code instructions for the workspace capability informed peripheral device purchase recommendation system 286 may execute to identify a number of available ports, such as 236 or 237 at an anchor node that are not currently in use by existing peripheral devices 251 or 254 within the user-identified peripheral device workspace 250, and power capabilities for those available ports 236 or 237. For example, code instructions for the workspace capability informed peripheral device purchase recommendation system 286 may execute to determine that the available port 236 can supply 15 Watts (W) of power, according to the USB-C standard, and that the available port 237 can supply 2.5 W of power, according to the USB-A or USB 2.0 standard. In other embodiments, one or more of ports 236 or 237 may not be capable of supplying power, such as in accordance with the high-definition multimedia interface (HDMI) standard, the DisplayPort (DP) standard, or the mini-DP standard.

Code instructions for the workspace capability informed peripheral device purchase recommendation system 286 may execute in an embodiment to search the orchestrated devices descriptors (ODDs) in the device catalog 285 to identify a plurality of peripheral devices, such as 292, 293, 294, or 295 for purchase from the product purchase platform 273 having power and connectivity requirements that can be met by one or both of the identified available anchor node ports 236 or 237. As described herein, each peripheral device available for purchase at the product purchase platform 273 may be associated with an orchestrated device descriptor (ODD) which includes a description of all non-configurable aspects of the peripheral device available for purchase (e.g., 291, 292, 293, 294, or 295), such as the type of port connection(s) required for operative coupling with a peripheral device workspace anchor node information handling system 230 and power delivery requirements via those connections, if any. The ODD may also identify the configurable capabilities of such a device (e.g., 291, 292, 293, 294, or 295), and may be accessible by the product purchase platform 273.

Code instructions for the workspace capability informed peripheral device purchase recommendation system 286 may execute to compare the non-configurable capabilities of the any of the peripheral devices available for purchase, such as 291, 292, 293, 294, or 295, as described within the retrieved ODD, to the port connectivity and power delivery capabilities for the user's information handling system 230 as defined within the retrieved peripheral device workspace anchor node status update document. For example, code instructions for the workspace capability informed peripheral device purchase recommendation system 286 may execute to determine that the type of port connection for the peripheral devices 292, 293, 294, or 295, match the type of port connection available at the anchor information handling system node 230, as given within the peripheral device workspace primary node status update document. More specifically, code instructions for the workspace capability informed peripheral device purchase recommendation system 286 may execute to determine that the type of port connection for the peripheral devices 292, 293, 294, or 295 require communication according to a communication protocol, such as USB-C, and that the available port 236 communicates according to this communication protocol. In another example, code instructions for the workspace capability informed peripheral device purchase recommendation system 286 may execute to determine that the type of port connection for the peripheral devices 292, 293, 294, or 295 require a minimum power supply, such as 100 Watts, supported by the USB Power Delivery (USB-PD) communication protocol, and that the available port 236 provides power meeting this minimum power requirement. The USB-PD communication protocol adheres to the same communication requirements as the USB-C communication protocol and uses the same interface type as USB-C, but requires the ability to supply much higher power values (e.g., 100 W for USB-PD in contrast to 15 W for USB-C) via this same type of interface.

Code instructions for the workspace capability informed peripheral device purchase recommendation system 286 may also execute to determine that the type of port connection for the new peripheral device 291 does not match the type of port connection available at the anchor information handling system node 230, as given within the peripheral device workspace primary node status update document. More specifically, code instructions for the workspace capability informed peripheral device purchase recommendation system 286 may execute to determine that the type of port connection for the new peripheral device 291 requires communication according to a first communication protocol, such as USB-C, and that the available ports 236 and 237 do not communicate according to this first communication protocol. In another example, code instructions for the workspace capability informed peripheral device purchase recommendation system 286 may execute to determine that the type of port connection for the new peripheral device 291 requires a minimum power supply, such as 100 amps supplied according to USB-PD, and that the available ports 236 and 237 do not provide power meeting this minimum power requirement.

The execution of the workspace capability informed peripheral device purchase recommendation system 286 in an embodiment may instruct the product purchase platform to filter purchase search results at the product purchase platform to include only the identified plurality of peripheral devices or may generate its own search results for presentation to the user or ITDM. For example, code instructions for the workspace capability informed peripheral device purchase recommendation system 286 may execute to instruct the product purchase platform 273 to filter purchase search results at the product purchase platform to include peripheral device 292, 293, 294, and 295. In another example embodiment, code instructions for the workspace capability informed peripheral device purchase recommendation system 286 may execute to instruct the product purchase platform 273 to filter purchase search results at the product purchase platform to exclude peripheral device 291. In such a way, code instructions of the workspace capability informed peripheral device purchase recommendation system 286 in an embodiment may be executed to send instructions to and work in tandem with the product purchase platform 273 to filter the search results at the product purchase platform for peripheral devices available to purchase according to a determined port availability and power capability limitation for the anchor node of the peripheral device workspace into which the user indicates an intention to incorporate the newly purchased peripheral device.

In another example embodiment, code instructions of the workspace capability informed peripheral device purchase recommendation system 286 may be executed to work in tandem with the product purchase platform 270 to recommend any extra hardware needed to support purchase of a user-selected peripheral device 291, based on the determined port availability and power capability limitations for an anchor information handling system node 230 of the peripheral device workspace 250 into which the user intends to incorporate the selected peripheral device 291 for purchase. The user of anchor information handling system node 230 in an embodiment may select, via the product purchase platform 273, a new peripheral device 291 for purchase, having a specific peripheral device type (e.g., mouse, keyboard, external display, webcam, etc.) listed within its ODD, as stored at the device catalog 285. As described herein, the device catalog 285 may be accessible by the workspace capability informed peripheral device purchase recommendation system 286, and the cloud manageability orchestration module 282. As also described herein, such an ODD for the peripheral devices available for purchase, such as 291, 292, 293, 294, or 295 may include a description of all non-configurable aspects of the peripheral devices 291, 292, 293, 294, or 295, such as connectivity requirements identifying one or more communication protocols or port types that can be used for operative coupling with the peripheral devices and power requirements for such an operative coupling. The ODD may also describe the configurable capabilities of such a device 291, a unique peripheral device identifier such as a serial number, and a peripheral device type classification, such as a mouse or an external display device.

More specifically, the ODD for the new peripheral device 291 in a first example embodiment may be retrieved through execution of code instructions by the workspace capability informed peripheral device purchase recommendation system 286 from the device catalog 285. The ODD in such an embodiment may indicate that the new peripheral device 291 requires operative coupling via a port capable of communication according to the USB-C communication protocol and capable of delivering at least 15 W of power to the new peripheral device 291 via that port. In another example embodiment, the ODD for the new peripheral device 291 may indicate that the new peripheral device 291 requires operative coupling via a port capable of communication according to the USB-A communication protocol and capable of delivering at least 2.5 W of power to the new peripheral device 291 via that port. According to another example embodiment, the ODD for the new peripheral device 291 may indicate that the new peripheral device 291 requires operative coupling via a port capable of communication according to the USB 2.0 communication protocol and capable of delivering at least 2.5 W of power to the new peripheral device 291 via that port. Although the USB-A and USB 2.0 communication protocols involve similar power requirements, different physical interfaces are used in each of these embodiments.

In yet another example embodiment, the ODD for the new peripheral device 291 may indicate that the new peripheral device 291 requires operative coupling via a port capable of communication according to the HDMI, Display Port, or miniDP communication protocols. In still another example embodiment, the ODD may indicate that the new peripheral device 291 requires operative coupling via a port capable of communication according to the USB-C communication protocol and capable of delivering at least 100 W of power to the new peripheral device 291 via that port, according to the USB power delivery (USB-PD) supplement to the USB-C communication protocol. As described herein, the USB-PD communication protocol adheres to the same communication requirements as the USB-C communication protocol and uses the same interface type as USB-C, but requires the ability to supply much higher power values (e.g., 100 W for USB-PD in contrast to 15 W for USB-C) via this same type of interface.

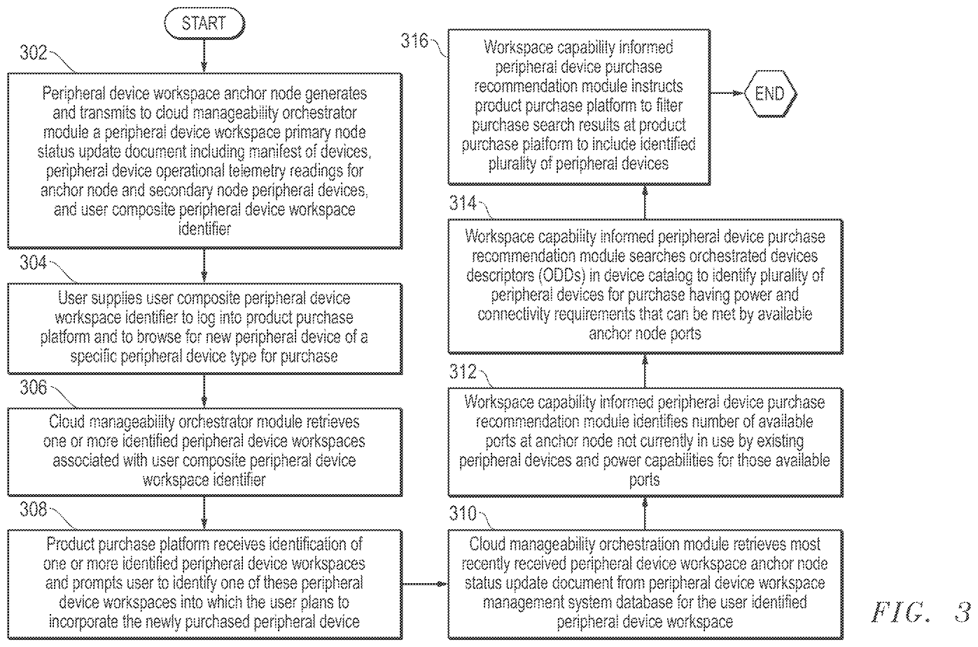

It may be determined in an embodiment, whether a port 236 or 237 identified as available and operational at the anchor node information handling system 230 for the identified and existing peripheral device workspace 250 can support the selected peripheral device 291 connectivity requirements. Code instructions for the workspace capability informed peripheral device purchase recommendation system 286 in an embodiment may execute to retrieve a recently received peripheral device workspace anchor node status update document for the workspace 250, as stored within the peripheral device workspace management system database 287 to identify capabilities for the ports 236 and 237. For example, code instructions for the workspace capability informed peripheral device purchase recommendation system 286 in an embodiment may execute to perform steps similar to blocks 304, 306, 308, and 310 of FIG. 3 above to retrieve the most recent peripheral device workspace anchor node status update document for the workspace 250, identified by the user of anchor information handling system node 230 as the workspace into which the user intends to incorporate the user-selected new peripheral device 291 for purchase.

More specifically, the recent peripheral device workspace anchor node status update document for the workspace 250 in one embodiment may indicate that both ports 236 and 237 are functioning normally and that port 236 supports USB 2.0 communication protocol with a maximum power delivery of 2.5 W, and port 237 supports USB-C communication protocol with a maximum power delivery of 15 W. In another example embodiment, the most recent peripheral device workspace anchor node status update document for the workspace 250 may indicate that port 236 is functioning normally and supports USB 2.0 communication protocol with a maximum power delivery of 2.5 W, while port 237 is designed to support the USB-C communication protocol with a maximum power delivery of 15 W, but it is currently not operational.

In an example embodiment, the user-selected new peripheral device 291 may require operative coupling via a port capable of communication according to the USB 2.0 communication protocol and capable of delivering at least 2.5 W of power. In such an example embodiment, code instructions for the workspace capability informed peripheral device purchase recommendation system 286 may execute to determine, via the peripheral device workspace anchor node status update document, that port 236 is available for operative coupling with peripheral device 291, is capable of communication according to the USB 2.0 communication protocol.

In another example embodiment, the user-selected new peripheral device 291 may require operative coupling via a port capable of communication according to the USB-A communication protocol and capable of delivering at least 2.5 W of power. In such an example embodiment, code instructions for the workspace capability informed peripheral device purchase recommendation system 286 may execute to determine, via the peripheral device workspace anchor node status update document, that neither port 236 or port 237 are capable of communication according to the USB-A communication protocol.

In another example embodiment, the user-selected new peripheral device 291 may require operative coupling via a port capable of communication according to the USB-C communication protocol and capable of delivering at least 15 Watts of power. In such an embodiment, code instructions for the workspace capability informed peripheral device purchase recommendation system 286 may execute to determine that port 236 is not capable of communication via the USB-C communication protocol. In one such an embodiment, code instructions for the workspace capability informed peripheral device purchase recommendation system 286 may execute to determine that port 237 is capable of communication via the USB-C communication protocol, but that it is non-functional.

In still another example embodiment, the user-selected new peripheral device 291 may require operative coupling via a port capable of communication according to the HDMI, Display Port, or miniDP communication protocols. In such an embodiment, code instructions for the workspace capability informed peripheral device purchase recommendation system 286 may execute to determine that neither port 236 or 237 are capable of communication via the HDMI, Display Port, or miniDP communication protocols.

In yet another example embodiment, the user-selected new peripheral device 291 may require operative coupling via a port capable of communication according to the USB-C communication protocol and capable of delivering at least 100 Watts of power according to the USB-PD supplement to the USB-C communication protocol. In such an embodiment, code instructions for the workspace capability informed peripheral device purchase recommendation system 286 may execute to may determine that port 237 is capable of communication via the USB-C communication protocol. Thus, port 237 may have the physical interface required for operative coupling under the USB-C and USB-PD communication protocols.

In an embodiment in which the user-selected peripheral device 291 has been determined to have connectivity supported by available ports 236 or 237 at the anchor information handling system node 230, it may be determined whether an available and operable port at the anchor information handling system node 230 can satisfy power requirements for the user-selected peripheral device for purchase. More specifically, in one embodiment, the workspace capability informed peripheral device purchase recommendation system 286 may have determined as described above, via the peripheral device workspace anchor node status update document, that port 236 is available for operative coupling with the user-selected peripheral device 291, and is capable of communication according to the USB 2.0 communication protocol required by the peripheral device 291. In such an embodiment, code instructions for the workspace capability informed peripheral device purchase recommendation system 286 may then execute to determine that the port 236 is also capable of delivering at least 2.5 W of power, as required by the peripheral device 291 under the USB 2.0 communication protocol. The workspace capability informed peripheral device purchase recommendation system 286 in such an embodiment may not interfere with the user's selected purchase of the new peripheral device 291 via the product purchase platform 273.

In another example embodiment, execution of code instructions of the workspace capability informed peripheral device purchase recommendation system 286 may have determined, via the peripheral device workspace anchor node status update document, that port 237 is available for operative coupling with the user-selected peripheral device 291, and is capable of communication according to the USB-C communication protocol required by the peripheral device 291. In such an embodiment, code instructions for the workspace capability informed peripheral device purchase recommendation system 286 may execute to then determine that the port 237 is not capable of delivering at least 100 W of power, as required by the peripheral device 291 under the USB-PD supplement to the USB-C communication protocol. In other words, the user-selected peripheral device 291 may be capable of operative coupling with port 237 through the USB-C type physical interface, and of communication via the USB-C communication protocol, but port 237 may not be capable of supplying the power required by peripheral device 291.

In an embodiment in which no ports identified as available and operational at the anchor node information handling system 230 for the identified and existing peripheral device workspace 250 can support the user-selected peripheral device 291 connectivity and power requirements, the code instructions for the workspace capability informed peripheral device purchase recommendation system 286 may execute to identify an alternative peripheral device 292 of the same peripheral device type as the user-selected peripheral device 291 having connectivity supported by available ports 236 or 237 at the anchor information handling system node 230. More specifically, the workspace capability informed peripheral device purchase recommendation system 286 may have determined in an embodiment at block 404 above that neither port 236 or port 237 are capable of communication via the USB-A communication protocol, as required by the user-selected peripheral device 291, which may be an external camera. In such an example embodiment, the code instructions for the workspace capability informed peripheral device purchase recommendation system 286 may execute to identify an alternative peripheral device 292 that is also an external camera, and is capable of operative coupling with port 237 via the USB-C communication protocol, which is supported by port 237. The code instructions for the workspace capability informed peripheral device purchase recommendation system 286 may further execute to determine that port 237 is capable of delivering power up to 15 W, which meets the power requirements for the alternative peripheral device external camera 292.

In another example embodiment, execution of code instructions of the workspace capability informed peripheral device purchase recommendation system 286 may determine in an embodiment that neither port 236 or port 237 are capable of communication via the USB-C communication protocol, as required by the user-selected peripheral device 291, which may be an external webcam. This may be the case in an example embodiment in which port 237 is a USB-C port, but is not currently functional. In such an example embodiment, code instructions for the workspace capability informed peripheral device purchase recommendation system 286 may execute to identify an alternative peripheral device 292 that is also an external webcam, and is capable of operative coupling with port 236 via the USB 2.0 communication protocol, which is supported by port 236. In other words, code instructions for the workspace capability informed peripheral device purchase recommendation system 286 may execute to identify an alternative peripheral device 292 that connects using the lower quality USB 2.0 communication protocol, rather than USB-C communication protocol by which the user-selected peripheral device 291 may operatively couple with any given port. The code instructions for the workspace capability informed peripheral device purchase recommendation system 286 may further execute to determine that port 236 is capable of delivering power up to 2.5 W, which meets the power requirements for the alternative peripheral device external webcam 292.

As still another example, the code instructions for the workspace capability informed peripheral device purchase recommendation system 286 may execute to determine that neither port 236 or 237 are capable of communication via the HDMI, Display Port, or miniDP communication protocols, one of which may be required by the user-selected new peripheral device 291, which may be an external display device. In such an example embodiment in which the only available and functional port 236 adheres to the USB 2.0 standard, the workspace capability informed peripheral device purchase recommendation system 286 may not be capable of identifying an alternative peripheral device 292 that is also an external display, and is capable of operative coupling with port 236 via the USB 2.0 communication protocol that is supported by port 236.

In an embodiment in which the code instructions for the workspace capability informed peripheral device purchase recommendation system 286 execute to identify an alternative peripheral device 292 that has communication protocol and power requirements that can be met by one or more available and operable ports 236 or 237, the code instructions for the workspace capability informed peripheral device purchase recommendation system 286 may further execute to recommend, via the product purchase platform 273, that the user purchase the alternative peripheral device 292, rather than the user-selected peripheral device 291. In an embodiment in which code instructions for the workspace capability informed peripheral device purchase recommendation system 286 executed to determine that there are no alternative peripheral devices available for purchase that have communication protocol and power requirements that can be met by one or more available and operable ports 236 or 237, code instructions for the workspace capability informed peripheral device purchase recommendation system 286 may execute to identify a port hub or port adapter that the user may purchase in addition to the user-selected peripheral device 291 to operatively couple the user-selected peripheral device 291 to the anchor information handling system node 230.

In an embodiment in which the workspace capability informed peripheral device purchase recommendation system 286 executed to recommend, via the product purchase platform, that the user purchase the alternative peripheral device, rather than the user-selected peripheral device, it may be determined whether the user or ITDM accepts this recommendation. The user or ITDM may choose not to accept such an alternative peripheral device purchase recommendation, for example, when the user or ITDM perceives the user-selected peripheral device to be an upgrade from the alternative peripheral device recommended for purchase. More specifically, the user or ITDM in an embodiment may refuse a recommendation to purchase an alternative webcam peripheral device 292 that communicates according to the USB 2.0 communication protocol supported by port 236 rather than the user-selected webcam peripheral device 291 that communicates according to the higher-quality USB-C communication protocol.

In other cases, the user or ITDM may choose to accept an alternative peripheral device purchase recommendation that she perceives to be of the same quality, or an upgrade from the user-selected peripheral device. For example, the user or ITDM in an embodiment may accept a recommendation to purchase an alternative external camera peripheral device 292 that communicates according to the USB-C communication protocol supported by port 237 rather than the user-selected external camera peripheral device 291 that communicates according to the lower-quality USB-A communication protocol.

If the user or ITDM approves of the recommendation to purchase the alternative peripheral device 292, the workspace capability informed peripheral device purchase recommendation system 286 may not interfere with the user's purchase of the alternative peripheral device via the product purchase platform 273. If the user or ITDM does not approve of the recommendation, the code instructions for the workspace capability informed peripheral device purchase recommendation system 286 may execute to identify port hubs or port adapters that that the user may purchase in addition to the user-selected peripheral device 291 to operatively couple the user-selected peripheral device 291 to the anchor information handling system node 230.

In an embodiment in which the user or ITDM does not approve of a recommended purchase of an alternative peripheral device 292, or in an embodiment in which no alternative peripheral devices could be identified, code instructions for the workspace capability informed peripheral device purchase recommendation system 286 may execute to identify one or more alternative combinations of the user-selected peripheral device 291 and port hubs 294 or port adapters 293 having connectivity supported by available and operable ports (e.g., 236) at the anchor information handling system node 230. For example, code instructions for the workspace capability informed peripheral device purchase recommendation system 286 may have executed to determine that neither port 236 or 237 are capable of communication via the HDMI communication protocols, that port 237 is disabled, and that no alternative external display peripheral devices are capable of operative coupling with port 236 via the USB 2.0 communication protocol that is supported by port 236. In such an example embodiment, code instructions for the workspace capability informed peripheral device purchase recommendation system 286 may execute to identify one or more alternative combinations of the user-selected peripheral device 291 and a port hub 294 or port adapter 293 that is capable of operative coupling with the user-selected peripheral device 291 via the HDMI communication protocol required by the user-selected peripheral device 291 and that is capable of operative coupling with port 236 according to the USB 2.0 communication protocol.

As another example, code instructions for the workspace capability informed peripheral device purchase recommendation system 286 may have executed to determine that the user has refused a recommendation to purchase an alternative webcam peripheral device 292 that communicates according to the USB 2.0 communication protocol supported by port 236 rather than the user-selected webcam peripheral device 291 that communicates according to the higher-quality USB-C communication protocol. In such an example embodiment, code instructions for the workspace capability informed peripheral device purchase recommendation system 286 may execute to identify one or more alternative combinations of the user-selected webcam peripheral device 291 and a port hub 294 or port adapter 293 that is capable of operative coupling with the user-selected webcam peripheral device 291 via the USB-C communication protocol required by the user-selected peripheral device 291 and that is capable of operative coupling with port 236 according to the USB 2.0 communication protocol.

It may be determined in an embodiment by execution of code instructions for the workspace capability informed peripheral device purchase recommendation system whether the available and operable ports of the anchor node can meet the connectivity and power requirements for the identified combination of port adapter or port hub and the user-selected peripheral device. For example, code instructions for the workspace capability informed peripheral device purchase recommendation system 286 may execute to identify one or more alternative combinations of the user-selected peripheral device 291 and a port hub 294 or port adapter 293 that is capable of operative coupling with the user-selected peripheral device 291 via the HDMI communication protocol required by the user-selected peripheral device 291 and that is capable of operative coupling with port 236 according to the USB 2.0 communication protocol. Such a port hub 294 or port adapter 293 may not need to adhere to any specific power requirements as the HDMI operative coupling does not require power transfer from the anchor information handling system node 230 to the peripheral device 291, or vice versa. Thus, code instructions for the workspace capability informed peripheral device purchase recommendation system 286 may execute to determine that the combination of the available port 236 of the anchor information handling system node 230 and the port adapter 293 or port hub 294 can meet the power requirements and connectivity requirements, such as communication via the HDMI communication protocol, for the user-selected peripheral device 291. In such an example embodiment, code instructions for the workspace capability informed peripheral device purchase recommendation system 286 may execute to recommend that the user of anchor information handling system node 230 purchase the adapter 293 or hub 294 that is capable of operative coupling with the user-selected peripheral device 291 via the HDMI communication protocol required by the user-selected peripheral device 291 and that is capable of operative coupling with port 236 according to the USB 2.0 communication protocol in addition to the purchase of the user-selected peripheral device 291.

As another example, code instructions for the workspace capability informed peripheral device purchase recommendation system 286 in an embodiment may execute to identify one or more alternative combinations of the user-selected peripheral device 291 and a port hub 294 or port adapter 293 that is capable of operative coupling with the user-selected peripheral device 291 via the USB-C communication protocol required by the user-selected peripheral device 291 and that is capable of operative coupling with port 236 according to the USB 2.0 communication protocol. Such a combination of the port adapter 293 or port hub 294 and the user-selected peripheral device 291 may still require power delivery via an operatively coupled port of 15 W, according to the USB-C communication protocol. Port 236, in contrast, may only be capable of delivering up to 2.5 W of power. Thus, code instructions for the workspace capability informed peripheral device purchase recommendation system 286 may execute to determine that the combination of the available port 236 of the anchor information handling system node 230 and the port adapter 293 or port hub 294 cannot meet the power requirements of up to 15 W for the user-selected peripheral device 291. In such an example embodiment, code instructions for the workspace capability informed peripheral device purchase recommendation system 286 may execute to recommend that the user of anchor information handling system node 230 purchase the user-selected peripheral device 291 along with a docking station 295 having its own power source that is capable of delivering the 15 W required by the user-selected peripheral device 291. In such a way, code instructions of the workspace capability informed peripheral device purchase recommendation system may be executed to work in tandem with the product purchase platform to recommend any extra hardware needed to support purchase of a user-selected peripheral device, based on the determined port availability and power capability limitations for an anchor node of the peripheral device workspace into which the user or ITDM intends to incorporate the selected peripheral device for purchase.

FIG. 3 is a flow diagram illustrating a method of executing code instructions for the workspace capability informed peripheral device purchase recommendation system on a peripheral device workspace cloud orchestrator server for instructing a product purchase platform executing at a vendor or manufacturer server to filter search results from a user-initiated search for a new peripheral device based on incorporation into an existing peripheral device workspace according to an embodiment of the present disclosure. Execution of code instructions for the workspace capability informed peripheral device purchase recommendation system to generate filtering of search results at the product purchase platform is conducted based on availability and functionality of ports in an anchor node information handling system and connectivity within the existing peripheral device workspace for which the new peripheral device is to be used. As described herein, peripheral devices within a given peripheral device workspace may operatively couple to a user's anchor node information handling system within the peripheral device workspace via various types of ports, hubs, or docking stations. For example, peripheral devices may connect to a peripheral device workspace anchor node information handling system via Universal Serial Bus (USB) standardized ports, such as USB-A, USB 2.0, or USB-C, or via other standardized ports, such as High Definition Multi-Media Interface (HDMI), DisplayPort (DP), Mini-DP, or audio in/out. In addition, some of these port types may support the transfer of power via the port, such as USB-C, while others such as USB-A or USB 2.0 do not. In some cases, docking stations, hubs, or adapters may be used to increase the number of a certain type of port available to the user. Users routinely have a plurality of peripheral devices plugged into these ports, docking stations, hubs, or adapters, leaving only one or a few available for further connection to other peripheral devices. In addition, one or more of these ports may be disabled or non-functional at a given time.

A user or ITDM visiting an online product purchase platform for purchase of a new peripheral device for incorporation within an existing peripheral device workspace in an embodiment may not be aware of the capabilities, availability, and functionality of such anchor node ports during such a purchase. This may allow a user to purchase a peripheral device only to determine it is incompatible with the capabilities of the user's current peripheral device workspace, which may require return of the purchased peripheral device, or purchase of additional hubs, adapters, or docking stations before the user can effectively use the newly purchased peripheral device. Code instructions of the workspace capability informed peripheral device purchase recommendation system in an embodiment may be executed to work in tandem with the product purchase platform to filter the search results at the product purchase platform for peripheral devices available to purchase according to a determined port availability and power capability limitation for the anchor node of the peripheral device workspace into which the user indicates an intention to incorporate the newly purchased peripheral device.

At block 302, a peripheral device workspace anchor node in an embodiment may generate and transmit to a cloud manageability orchestrator module a peripheral device workspace primary node status update document. This may include a manifest of devices under a peripheral device workspace identification value, peripheral device operational telemetry readings for the anchor node and secondary node peripheral devices, and a user composite peripheral device workspace identifier for the user of the anchor node. For example, in an embodiment described with reference to FIG. 2, a peripheral device workspace anchor information handling system node 230 may generate and transmit to a cloud manageability orchestrator module 282 a peripheral device workspace primary node status update document. This may include a manifest of devices in the peripheral device workspace and associated with the peripheral device workspace identification value for that peripheral device workspace, peripheral device operational telemetry readings for the anchor information handling system node 230 and secondary node peripheral devices 251 and 254, and a user composite peripheral device workspace identifier for the user of the anchor information handling system node 230. As described herein, each time a peripheral device configuration setting is changed by the user, a new peripheral device, such as 291, 292, 293, 294, or 295 is added to the peripheral device workspace 250, or changes to environmental context data for the peripheral device workspace 250 are detected, a new peripheral device workspace 250 anchor node status update document including this updated configuration may be transmitted to the peripheral device workspace cloud orchestrator 280. The peripheral device workspace anchor node status update document is transmitted for storage with the peripheral device workspace identification value at the peripheral device workspace management system database 287 operating in the peripheral device workspace cloud orchestrator 280.

These peripheral device operational telemetry readings may include for example, time of day, applications being executed, wireless or wired connection capabilities of nodes, status or functionality of one or more ports 235, 236, or 237 of the anchor node user information handling system 230 for connection to peripheral devices 251, 254, or peripheral devices for purchase, such as 291, 292, 293, 294, or 295 within a peripheral device workspace 250, security credentials for the user, and other workspace data. More specifically, these peripheral device operational telemetry readings may indicate that port 235 is not available for operative connection with any newly purchase peripheral devices 291, 292, 293, 294, or 295 because it is already operatively coupled to secondary node 251. As another example, these peripheral device operational telemetry readings may indicate that ports 236 and 237 are available for operative coupling with a newly purchased peripheral device 291, 292, 293, 294, or 295, and may provide port connectivity capabilities describing the communication protocols under which such ports 236 and 237 may operatively couple, as well as power delivery capabilities for ports 236 or 237 upon such an operative coupling.

As also described herein, the ODD for existing peripheral devices such as 230, 251, or 254 or the peripheral devices available for purchase, such as 291, 292, 293, 294, or 295 includes a description of all non-configurable aspects of the peripheral devices 230, 251, 254, 291, 292, 293, 294, or 295, such as connectivity requirements identifying one or more communication protocols or port types that can be used for operative coupling with the peripheral devices and power requirements for such an operative coupling. The ODD may also include the configurable capabilities of such a device, a unique peripheral device identifier such as a serial number, and a peripheral device type classification (e.g., mouse, display, keyboard, webcam, etc.). As described herein, each registered user, such as the user of anchor information handling system node 230 may be associated with a user composite peripheral device workspace identifier, generated and maintained by the peripheral device workspace cloud orchestrator 280 and with data such as configuration settings stored for each of the nodes (e.g., 230, 251, and 254) of a peripheral device workspace (e.g., 250). This user composite peripheral device workspace identifier for each user may include an identification of a single user, the plurality of peripheral device workspaces 250 and 260 associated with that user, and the plurality of peripheral devices 251 and 254 that have been operatively coupled to the user's information handling system 230, as well as peripheral device operational and environmental context telemetry readings previously received by the peripheral device workspace cloud orchestrator 280 executing at a peripheral device workspace cloud orchestrator server from the information handling system 230 or from smart peripheral devices such as 254.

In an embodiment at block 304, a user of a product purchase platform or an ITDM, may log on with an information handling system that may or may not be serving as an anchor node for an existing peripheral device workspace and may supply log in credentials or other authorization credentials identifying the user and which may be used to access a user composite peripheral device workspace identifier for the user. The user or ITDM may browse for a new peripheral device of a specific peripheral device type for purchase and incorporation within an existing peripheral device workspace. The product purchase platform software may be code instructions executing at servers supporting a purchase website for a vendor or a manufacturer. For example, in an embodiment described with reference to FIG. 2, a user of a product purchase platform 273 or an ITDM may supply credentials of a user which may be sent to executing code instructions for the workspace capability informed peripheral device purchase recommendation system 286 at a peripheral device workspace cloud orchestrator server. The user or ITDM may browse for a new peripheral device 291 of a specific peripheral device type for purchase and incorporation within an existing peripheral device workspace 250 or 260 and for an anchor information handling system node 230 that will operate in an existing peripheral device workspace 250 or 260. Code instructions for the workspace capability informed peripheral device purchase recommendation system 286 will execute to determine a user composite peripheral device workspace identifier for the user from user identification provided by the browsing user or ITDM on the product purchase platform 273 and to the workspace capability informed peripheral device purchase recommendation system 286.

As described herein, the user composite peripheral device workspace identifier is unique to the individual user of the anchor information handling system node 230 for one or more defined peripheral device workspaces 250 or 260 that are associated with identification of the user or the user's information handling system and peripheral device workspace identification values of the peripheral device workspaces 250 or 260 used by that user. Thus, a user composite peripheral device workspace identifier may identify a single user of an anchor node information handling system, and a peripheral device workspace identification value for each of one or more peripheral device workspaces 250 or 260 in which the user's information handling system 230 operates as an anchor node at various times. The user composite peripheral device workspace identifier may thus be user-specific and user-centric. The peripheral device workspace identification value, in comparison, may define a location and list of peripheral device nodes such as 230, 251 and 254 for peripheral device workspace 250, and may thus be peripheral device workspace-centric.

At block 306, a cloud manageability orchestrator module in an embodiment may retrieve one or more identified peripheral device workspace identification values associated with the user composite peripheral device workspace identifier supplied by the browsing user. In an example embodiment, a cloud manageability orchestrator module 282 executing at the peripheral device workspace cloud orchestrator server may receive a user identification from execution of the code instructions for the workspace capability informed peripheral device purchase recommendation system 286 and may retrieve one or more identified peripheral device workspace identification values associated with the user composite peripheral device workspace identifier for the browsing user. As described herein, a user composite peripheral device workspace identifier may identify a single user of an anchor node information handling system, such as 230, and a peripheral device workspace identification value for each of one or more peripheral device workspaces 250 or 260 in which the user's information handling system 230 operates as an anchor node at various times. In such an example embodiment, the cloud manageability orchestrator module 282 may retrieve peripheral device workspace identification values for both the peripheral device workspace 250 and the peripheral device workspace 260, for both of which the user information handling system 230 has previously served as an anchor node. The cloud manageability orchestrator module 282 may perform this step in an embodiment and respond to the workspace capability informed peripheral device purchase recommendation system 286 in order to assist in identifying the peripheral device workspace 250 or 260 into which the user intends to incorporate the peripheral device intended for purchase via the product purchase platform 273. Only after such a determination is made may execution of code instructions of the workspace capability informed peripheral device purchase recommendation system 286 assist the purchasing user in selecting products compatible with available and operational ports for the anchor information handling system node 230.

The code instructions for the workspace capability informed peripheral device purchase recommendation system 286 in an embodiment at block 308 may receive an identification of the one or more peripheral device workspaces identified at block 306 and may execute to prompt the browsing user or ITDM of the product purchase platform to identify one of these peripheral device workspaces into which the user plans to incorporate the newly purchased peripheral device. For example, execution of code instructions for the workspace capability informed peripheral device purchase recommendation system 286 in an embodiment may receive an identification of the one or more peripheral device workspaces 250 or 260 and prompt the browsing user at the product purchase platform 273 to identify one of these peripheral device workspaces 250 or 260 into which the user plans to incorporate the newly purchased peripheral device. The user may select either peripheral device workspace 250 or peripheral device workspace 260 for planned incorporation of the new peripheral device in an embodiment. For example, the user may plan to incorporate the new peripheral device into a home peripheral device workspace 260 or an office peripheral device workspace 250. In an embodiment, the user may select or indicate that the new peripheral device for purchase via the product purchase platform 273 will be incorporated within the peripheral device workspace 250, for example.

Each of these peripheral device workspaces 250 or 260 may include a different set of existing peripheral devices, such as 251 and 254 for peripheral device workspace 250, to which the user's information handling system 230 is operatively coupled when it operates within those peripheral device workspaces 250 or 260. The ways in which such existing peripheral devices operatively couple with the anchor information handling system node 230 may vary between the two peripheral device workspaces 250 or 260. For example, when the user information handling system 230 operates within the peripheral device workspace 250, it may operatively couple to the smart peripheral device 254 via a wireless link, and to the secondary peripheral device node 251 via a wired connection through port 235, leaving ports 236 and 237 available for further wired connection to other peripheral devices, such as the peripheral device the user is interested in purchasing. In contrast, when operating in the peripheral device workspace 260, the anchor information handling system node 230 in one example embodiment may operatively couple with any existing peripheral devices within that workspace using only wireless links, leaving each of ports 235, 236, and 237 available for connection to other peripheral devices. In another example embodiment, when operating in the peripheral device workspace 260, the anchor information handling system node 230 may use both ports 235 and 236 for wired operative coupling with existing peripheral devices, leaving only port 237 available for operative coupling with other peripheral devices. Thus, in order to recommend purchase of products having power and connectivity requirements that can be met by available and operative ports at the anchor information handling system node 230, execution of code instructions of the workspace capability informed peripheral device purchase recommendation system 286 must first determine which peripheral device workspace 250 or 260 into which the user intends to incorporate the newly purchased peripheral device to access in the configuration data for that managed peripheral device workspace from the peripheral device workspace management system database 287.

At block 310, the cloud manageability orchestration module in an embodiment may retrieve a recently received peripheral device workspace anchor node status update document from the peripheral device workspace management system database for the user identified peripheral device workspace. For example, cloud manageability orchestration module 282 in an embodiment may retrieve a recently received peripheral device workspace anchor node status update document including configuration data for device nodes in an intended peripheral device workspace from the peripheral device workspace management system database 287 for the user identified peripheral device workspace 250. As described herein, the peripheral device workspace anchor node status update document may include one or more peripheral device operational telemetry readings (e.g., time, applications executing, status or functionality of one or more ports of the anchor node user information handling system for connection to peripheral devices within a peripheral device workspace, or other telemetry data indicating usage patterns for the information handling system in a peripheral device workspace), and one or more peripheral device configuration settings (e.g., resolution for an external display device) for the operably coupled peripheral devices. These peripheral device operational telemetry readings may indicate which of the ports 235, 236, or 237 at the anchor information handling system node 230 are operatively coupled to other peripheral device nodes, such as 235 operatively coupled to peripheral device 251, and which are available for connection to other peripheral device nodes, such as any selected for purchase via the product purchase platform 273. The functionality of each of the ports 235, 236, or 237, identifying the ports 235, 236, or 237 as either functional or disabled or broken may also be included within the peripheral device operational telemetry readings.

In an embodiment at block 312, execution of code instructions of the workspace capability informed peripheral device purchase recommendation system may identify a number of available ports at an anchor information handling system node that are not currently in use by existing peripheral devices within the user-identified peripheral device workspace, and power capabilities for those available ports. For example, in an embodiment, code instructions for the workspace capability informed peripheral device purchase recommendation system 286 may execute to identify a number of available ports, such as 236 or 237 at an anchor node that are not currently in use by existing peripheral devices 251 or 254 within the user-identified peripheral device workspace 250, and power capabilities for those available ports 236 or 237. Execution of code instructions for the workspace capability informed peripheral device purchase recommendation system 286 may access peripheral device workspace environmental telemetry data and records for configurations at the identified intended peripheral device workspace from the database 287 and determine from those which ports are currently in use and which are not. More specifically, code instructions for the workspace capability informed peripheral device purchase recommendation system 286 may execute to determine that the available port 236 can supply 15 Watts (W) of power, according to the USB-C standard, and that the available port 237 can supply 2.5 W of power, according to the USB-A standard from peripheral device workspace identification values and associated telemetry data for the intended peripheral device workspace 250 when an anchor information handling system node 230 is located there. In other embodiments, one or more of ports 236 or 237 may not be capable of supplying power, such as in accordance with the high-definition multimedia interface (HDMI) standard, the DisplayPort (DP) standard, or the mini-DP standard.

At block 314, execution of the code instructions of the workspace capability informed peripheral device purchase recommendation system in an embodiment may search the orchestrated devices descriptors (ODDs) in the device catalog to identify plurality of peripheral device nodes for purchase having power and connectivity requirements that can be met by the identified available anchor node ports. For example, code instructions for the workspace capability informed peripheral device purchase recommendation system 286 may execute to search the orchestrated devices descriptors (ODDs) in the device catalog 285 to identify a plurality of peripheral devices, such as 292, 293, 294, or 295 for purchase having power and connectivity requirements that can be met by one or both of the identified available anchor node ports 236 or 237 determined above. As described herein, each peripheral device available for purchase at the product purchase platform 273 may be associated with an orchestrated device descriptor (ODD) which includes a description of all non-configurable aspects of the peripheral device available for purchase (e.g., 291, 292, 293, 294, or 295), such as the type of port connection(s) required for operative coupling with a peripheral device workspace anchor node information handling system 230 and power delivery requirements via those connections, if any.

Code instructions for the workspace capability informed peripheral device purchase recommendation system 286 may execute to determine that the type of port connection for the peripheral devices available for purchase, such as 292, 293, 294, or 295, match the type of port connection available at the anchor information handling system node 230 when in the peripheral device workspace 250, as given within the peripheral device workspace primary node status update document. More specifically, code instructions for the workspace capability informed peripheral device purchase recommendation system 286 may execute to determine that the type of port connection for the peripheral devices available for purchase 292, 293, 294, or 295 will require communication according to a communication protocol, such as USB-C, and that the available port 236 communicates according to this communication protocol. In another example, code instructions for the workspace capability informed peripheral device purchase recommendation system 286 may execute to determine that the type of port connection for the peripheral devices 292, 293, 294, or 295 require a minimum power supply, such as 15 Watts supplied according to USB-C, and that the available port 236 provides power meeting this minimum power requirement.

Code instructions for the workspace capability informed peripheral device purchase recommendation system 286 may also execute to determine that the type of port connection for the new peripheral device 291 does not match the type of port connection available at the anchor information handling system node 230, as given within the peripheral device workspace primary node status update document. More specifically, code instructions for the workspace capability informed peripheral device purchase recommendation system 286 may execute to determine that the type of port connection for the new peripheral device 291 requires communication according to a first communication protocol, such as USB-C, and that the available ports 236 and 237 do not communicate according to this first communication protocol. In another example, code instructions for the workspace capability informed peripheral device purchase recommendation system 286 may execute to determine that the type of port connection for the new peripheral device 291 requires a minimum power supply, such as 15 Watts supplied according to USB-C, and that the available ports 236 and 237 do not provide power meeting this minimum power requirement.

Execution of the code instructions for the workspace capability informed peripheral device purchase recommendation system in an embodiment at block 316 may instruct the product purchase platform to filter purchase search results at the product purchase platform to include only the identified plurality of peripheral devices. The workspace capability informed peripheral device purchase recommendation system in an embodiment at block 316 may execute at the peripheral device workspace cloud orchestrator server to instruct the product purchase platform executing at a vendor or manufacturer server to filter purchase search results at the product purchase platform to include only the identified plurality of peripheral devices. For example, execution of code instructions for the workspace capability informed peripheral device purchase recommendation system 286 in an embodiment may instruct the product purchase platform 273 to filter purchase search results at the product purchase platform to include peripheral device 292, 293, 294, and 295. In another example embodiment, the workspace capability informed peripheral device purchase recommendation system 286 may instruct the product purchase platform 273 to filter purchase search results at the product purchase platform to exclude peripheral device 291.

In such a way, code instructions of the workspace capability informed peripheral device purchase recommendation system in an embodiment may be executed to work in tandem with the product purchase platform to filter the search results at the product purchase platform for peripheral devices available to purchase according to a determined port availability and power capability limitation for the anchor node of the peripheral device workspace into which the user indicates an intention to incorporate the newly purchased peripheral device. The method for filtering search results at a product purchase platform for a user-initiated search for a new peripheral device for incorporation into an existing peripheral device workspace based on availability and functionality of ports in an anchor node information handling system of the existing peripheral device workspace may then end.

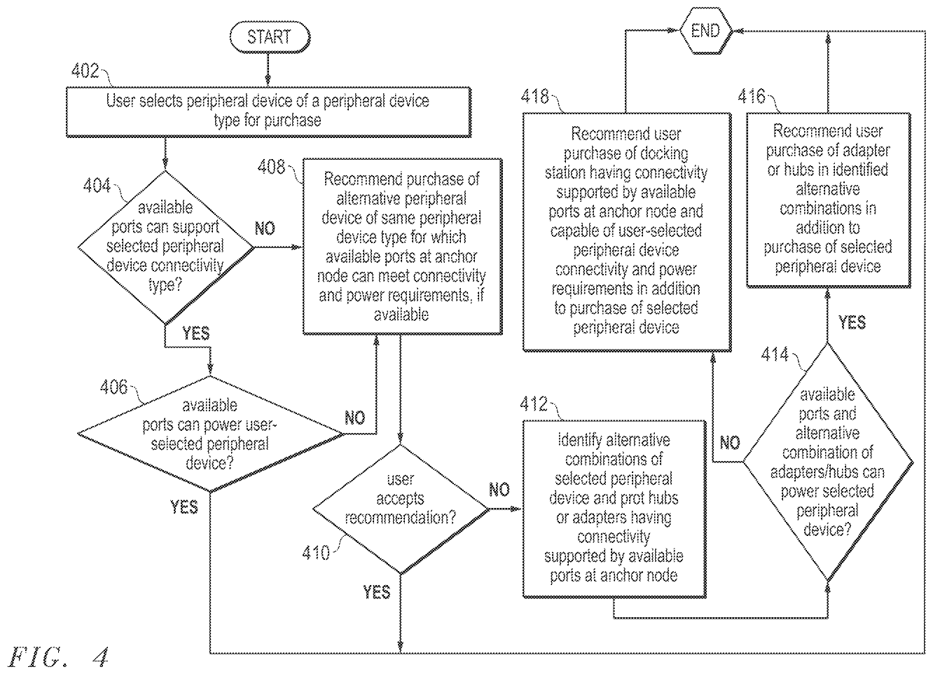

FIG. 4 is a flow diagram illustrating a method of executing code instructions of a code instructions for the workspace capability informed peripheral device purchase recommendation system at a peripheral device workspace cloud orchestrator server managing a plurality of peripheral device workspaces in an enterprise to recommend user purchase of a peripheral device, port hub, port adapter, or docking station as an alternative or supplemental to a peripheral device selected by a user for purchase and incorporation into an existing peripheral device workspace according to an embodiment of the present disclosure. Execution of code instructions of the workspace capability informed peripheral device purchase recommendation system may determine recommendation based on availability and functionality of ports in an anchor node information handling system of the existing peripheral device workspace as determined from access to telemetry data associated with managed peripheral device workspaces by execution of the peripheral device workspace orchestrator system according to embodiments herein. As described herein, peripheral device nodes within a given peripheral device workspace may operatively couple to a user's anchor node information handling system within the peripheral device workspace via various types of ports, hubs, or docking stations. Users routinely have a plurality of peripheral devices plugged into these ports, docking stations, hubs, or adapters, leaving only one or a few available for further connection to other peripheral devices. In addition, one or more of these ports may be disabled or non-functional at a given time.

A user or ITDM visiting an online product purchase platform for purchase of a new peripheral device for incorporation within an existing peripheral device workspace in an embodiment may not be aware of the capabilities, availability, and functionality of such anchor node ports during such a purchase. This may allow a user to purchase a peripheral device only to determine it is incompatible with the capabilities of the user's current peripheral device workspace, which may require return of the purchased peripheral device, or purchase of additional hubs, adapters, or docking stations before the user can effectively use the newly purchased peripheral device. In an embodiment, code instructions of the workspace capability informed peripheral device purchase recommendation system may be executed to work in tandem with the product purchase platform to recommend any extra hardware needed to support purchase of a user-selected peripheral device, based on the determined port availability and power capability limitations for an anchor node of the peripheral device workspace into which the user intends to incorporate the selected peripheral device for purchase.

At block 402, a user or ITDM may access a product purchase platform software executing at a vendor or manufacturer server in an embodiment and may browse and select a peripheral device of a peripheral device type for purchase and incorporation within an identified and existing peripheral device workspace as monitored or assisted by code instructions for the workspace capability informed peripheral device purchase recommendation system as described in embodiments herein. For example, in an embodiment described with reference to FIG. 2, the user of anchor information handling system node 230 may select, via the product purchase platform 273, a new peripheral device 291 for purchase, having a specific peripheral device type (e.g., mouse, keyboard, external display, webcam, etc.) listed within its ODD, as stored at the device catalog 285. As described herein, the device catalog 285 may be accessible by the workspace capability informed peripheral device purchase recommendation system 286, and the cloud manageability orchestration module 282. As also described herein, such an ODD for the peripheral devices available for purchase, such as 291, 292, 293, 294, or 295 may include a description of all non-configurable aspects of the peripheral devices 291, 292, 293, 294, or 295, such as connectivity requirements identifying one or more communication protocols or port types that can be used for operative coupling with the peripheral devices and power requirements for such an operative coupling. The ODD may also include the configurable capabilities of such a new peripheral device 291, a unique peripheral device identifier such as a serial number, and a peripheral device type classification (e.g., mouse, display, keyboard, webcam, etc.). The selection of the new peripheral device 291 may have been assisted with recommendation by execution of code instructions for the workspace capability informed peripheral device purchase recommendation system at the peripheral device workspace cloud orchestrator servers according to embodiments herein or such a recommendation may have been declined and a peripheral device 291 selected nonetheless.

The ODD for the new peripheral device 291 in a first example embodiment may be retrieved by execution of code instructions of the workspace capability informed peripheral device purchase recommendation system 286 from the device catalog 285. The ODD in such an embodiment may indicate that the new peripheral device 291 requires operative coupling via a port capable of communication according to the USB-C communication protocol and capable of delivering at least 15 Watts of power to the new peripheral device 291 via that port. In another example embodiment, execution of code instructions for the workspace capability informed peripheral device purchase recommendation system 286 may determine that the ODD for the new peripheral device 291 indicates that the new peripheral device 291 requires operative coupling via a port capable of communication according to the USB-A communication protocol and capable of delivering at least 2.5 W of power to the new peripheral device 291 via that port. According to another example embodiment, the ODD for the new peripheral device 291 may indicate that the new peripheral device 291 requires operative coupling via a port capable of communication according to the USB 2.0 communication protocol and capable of delivering at least 2.5 W of power to the new peripheral device 291 via that port. Although the USB-A and USB 2.0 communication protocols involve similar power requirements, different physical interfaces are used in each of these embodiments.

In yet another example embodiment, execution of code instructions for the workspace capability informed peripheral device purchase recommendation system 286 may determine that the ODD for the new peripheral device 291 indicates that the new peripheral device 291 requires operative coupling via a port capable of communication according to the HDMI, Display Port, or miniDP communication protocols. In still another example embodiment, the ODD for the new peripheral device 291 may indicate that the new peripheral device 291 requires operative coupling via a port capable of communication according to the USB-C communication protocol and capable of delivering at least 100 W of power, pursuant to the USB power delivery (USB-PD) supplement to the USB-C communication protocol.

It may be determined in an embodiment, at block 404, whether a port identified as available and operational at the anchor node information handling system for the identified and existing peripheral device workspace can support the selected peripheral device connectivity requirements for the selected new peripheral device. For example, it may be determined in an embodiment, whether a port 236 or 237 identified as available and operational at the anchor node information handling system 230 for the identified and existing peripheral device workspace 250 can support the selected peripheral device 291 connectivity requirements. Execution of code instructions for the workspace capability informed peripheral device purchase recommendation system 286 at a peripheral device workspace orchestration server in an embodiment may retrieve a recently received peripheral device workspace anchor node status update document for the workspace 250, as stored within the peripheral device workspace management system database 287, to identify capabilities for the ports 236 and 237. For example, execution of code instructions of the workspace capability informed peripheral device purchase recommendation system 286 in an embodiment may perform steps similar to blocks 304, 306, 308, and 310 of FIG. 3 above to retrieve the recent peripheral device workspace anchor node status update document for the workspace 250 as identified by the user of anchor information handling system node 230 as the intended peripheral device workspace into which the user intends to incorporate the user-selected new peripheral device 291 for purchase. More specifically, execution of code instructions for the workspace capability informed peripheral device purchase recommendation system 286 may determine that the recent peripheral device workspace anchor node status update document for the workspace 250 in one embodiment indicates that both ports 236 and 237 are functioning normally and that port 236 supports USB 2.0 communication protocol with a maximum power delivery of 2.5 W, and port 237 supports USB-C communication protocol with a maximum power delivery of 15 W. In another example embodiment, execution of code instructions for the workspace capability informed peripheral device purchase recommendation system 286 may determine that the recent peripheral device workspace anchor node status update document for the workspace 250 indicates that port 236 is functioning normally and supports USB 2.0 communication protocol with a maximum power delivery of 2.5 W, while port 237 is designed to support the USB-C communication protocol with a maximum power delivery of 15 W, but it is currently not operational.

In an example embodiment, execution of code instructions for the workspace capability informed peripheral device purchase recommendation system 286 may determine that the user-selected new peripheral device 291 may require operative coupling via a port capable of communication according to the USB 2.0 communication protocol and capable of delivering at least 2.5 W of power. In such an example embodiment, code instructions for the workspace capability informed peripheral device purchase recommendation system 286 may execute to determine, via the peripheral device workspace anchor node status update document, that port 236 is available for operative coupling with peripheral device 291, is capable of communication according to the USB 2.0 communication protocol.

In another example embodiment, the user-selected new peripheral device 291 may require operative coupling via a port capable of communication according to the USB-A communication protocol and capable of delivering at least 2.5 W of power. In such an example embodiment, code instructions for the workspace capability informed peripheral device purchase recommendation system 286 may execute to determine, via the peripheral device workspace anchor node status update document, that neither port 236 or port 237 are capable of communication according to the USB-A communication protocol.

In another example embodiment, the user-selected new peripheral device 291 may require operative coupling via a port capable of communication according to the USB-C communication protocol and capable of delivering at least 15 Watts of power. In such an embodiment, code instructions for the workspace capability informed peripheral device purchase recommendation system 286 may execute to determine that port 236 is not capable of communication via the USB-C communication protocol. In one such an embodiment, code instructions for the workspace capability informed peripheral device purchase recommendation system 286 may execute to determine that port 237 is capable of communication via the USB-C communication protocol, but that it is non-functional.

In still another example embodiment, the user-selected new peripheral device 291 may require operative coupling via a port capable of communication according to the HDMI, Display Port, or miniDP communication protocols. In such an embodiment, code instructions for the workspace capability informed peripheral device purchase recommendation system 286 may execute to determine that neither port 236 or 237 are capable of communication via the HDMI, Display Port, or miniDP communication protocols.

In yet another example embodiment, the user-selected new peripheral device 291 may require operative coupling via a port capable of communication according to the USB-C communication protocol and capable of delivering at least 100 Watts of power according to the USB-PD supplement to the USB-C communication protocol. In such an embodiment, code instructions for the workspace capability informed peripheral device purchase recommendation system 286 may execute to determine that port 237 is capable of communication via the USB-C communication protocol. Thus, port 237 may have the physical interface required for operative coupling under the USB-C and USB-PD communication protocols.

If execution of code instructions for the workspace capability informed peripheral device purchase recommendation system 286 determines that no ports are identified as available and operational at the anchor node information handling system for the identified and existing peripheral device workspace that can support the selected peripheral device connectivity requirements, the method may proceed to block 408 for identification of alternative peripheral devices of the same peripheral device type as the selected peripheral device having connectivity and power requirements that can be met by the currently available and operable anchor node ports. If a port identified as available and operational at the anchor node information handling system for the identified and existing peripheral device workspace can support the selected peripheral device connectivity requirements, the method may proceed to block 406 for consideration of power requirements for the selected peripheral device.

In an embodiment where the user-selected peripheral device has been determined to have connectivity supported by available ports at the anchor information handling system node, it may be determined by execution of code instructions of the workspace capability informed peripheral device purchase recommendation system at block 406 whether an available and operable port at the anchor node can satisfy power requirements for the user-selected peripheral device for purchase. For example, in an embodiment in which the user-selected peripheral device 291 has been determined to have connectivity supported by available ports 236 or 237 at the anchor information handling system node 230, it may be determined through execution of code instructions for the workspace capability informed peripheral device purchase recommendation system 286 whether an available and operable port at the anchor information handling system node 230 can satisfy power requirements for the user-selected or identified alternative peripheral device for purchase. More specifically, in one embodiment, code instructions for the workspace capability informed peripheral device purchase recommendation system 286 may have executed to determine as described above, via the peripheral device workspace anchor node status update document, that port 236 is available for operative coupling with the user-selected peripheral device 291, and is capable of communication according to the USB 2.0 communication protocol required by the peripheral device 291. In such an embodiment, code instructions for the workspace capability informed peripheral device purchase recommendation system 286 may execute to determine that the port 236 is also capable of delivering at least 2.5 W of power, as required by the user-selected peripheral device 291 under the USB 2.0 communication protocol. The workspace capability informed peripheral device purchase recommendation system 286 in such an embodiment may not interfere with the user's selected purchase of the new peripheral device 291 via the product purchase platform 273 and the method may then end.

In another example embodiment, code instructions for the workspace capability informed peripheral device purchase recommendation system 286 may have executed to determine as described above, via the peripheral device workspace anchor node status update document, that port 237 is available for operative coupling with peripheral device 291, and is capable of communication according to the USB-C communication protocol required by the peripheral device 291. In such an embodiment, code instructions for the workspace capability informed peripheral device purchase recommendation system 286 may execute to determine that the port 237 is not capable of delivering at least 100 W of power, as required by the peripheral device 291 under the USB-PD supplement to the USB-C communication protocol. In other words, the peripheral device 291 may be capable of operative coupling with port 237 through the USB-C type physical interface, and of communication via the USB-C communication protocol, but port 237 may not be capable of supplying the power required by peripheral device 291.

If an available and operable port at the anchor node can satisfy power requirements for the user-selected peripheral device for purchase, the workspace capability informed peripheral device purchase recommendation system may not interfere with the user's selected purchase of the new peripheral device via the product purchase platform and the method may then end. If no available and operable port at the anchor node can satisfy power requirements for the user-selected peripheral device for purchase, the method may proceed to block 408 for identification of an alternative peripheral device of the same peripheral device type as the user-selected peripheral device to meet the connectivity and power requirements supported by the available and operable ports at the anchor node.

At block 408, in an embodiment in which no ports identified as available and operational at the anchor node information handling system for the identified and existing peripheral device workspace can support the selected peripheral device connectivity and any power requirements, execution of code instructions for the workspace capability informed peripheral device purchase recommendation system may identify an alternative peripheral device of the same peripheral device type as the user-selected peripheral device having connectivity supported by available ports at the anchor information handling system node in the intended peripheral device workspace managed by the peripheral device workspace orchestrator. For example, in an embodiment in which no ports identified as available and operational at the anchor node information handling system 230 for the identified and existing peripheral device workspace 250 can support the user-selected peripheral device 291 connectivity and power requirements, code instructions for the workspace capability informed peripheral device purchase recommendation system 286 may execute to identify an alternative peripheral device 292 of the same peripheral device type as the user-selected peripheral device 291 having connectivity supported by available ports 236 or 237 at the anchor information handling system node 230 when it is in the peripheral device workspace 250.

More specifically, code instructions for the workspace capability informed peripheral device purchase recommendation system 286 may have executed to determine in an embodiment at block 404 above that neither port 236 or port 237 are capable of communication via the USB-A communication protocol, as required by the user-selected peripheral device 291, which may be an external camera. In such an example embodiment, code instructions for the workspace capability informed peripheral device purchase recommendation system 286 may execute to identify an alternative peripheral device 292 that is also an external camera, and is capable of operative coupling with port 237 via the USB-C communication protocol, which is supported by port 237. Code instructions for the workspace capability informed peripheral device purchase recommendation system 286 may execute to determine that port 237 is capable of delivering power up to 15 W, which meets the power requirements for the alternative peripheral device 292 that is another external camera.

In another example embodiment, code instructions for the workspace capability informed peripheral device purchase recommendation system 286 may have executed to determine in an embodiment at block 404 above that neither port 236 or port 237 are capable of communication via the USB-C communication protocol, as required by the user-selected peripheral device 291, which may be an external webcam. This may be the case in an example embodiment in which port 237 is a USB-C port, but is not currently functional. In such an example embodiment, code instructions for the workspace capability informed peripheral device purchase recommendation system 286 may execute to identify an alternative peripheral device 292 that is also an external webcam, and is capable of operative coupling with port 236 via the USB 2.0 communication protocol, which is supported by port 236. In other words, code instructions for the workspace capability informed peripheral device purchase recommendation system 286 may execute to identify an alternative peripheral device 292 that connects using the lower quality USB 2.0 communication protocol, rather than USB-C communication protocol by which the user-selected peripheral device 291 may operatively couple with any given port. Code instructions for the workspace capability informed peripheral device purchase recommendation system 286 may then execute to determine that port 236 is capable of delivering power up to 2.5 W, which meets the power requirements for the alternative peripheral device external webcam 292.

As still another example, code instructions for the workspace capability informed peripheral device purchase recommendation system 286 may execute to determine that neither port 236 or 237 are capable of communication via the HDMI, Display Port, or miniDP communication protocols, one of which may be required by the user-selected new peripheral device 291, which may be an external display device. In such an example embodiment in which the only available and functional port 236 adheres to the USB 2.0 standard, the workspace capability informed peripheral device purchase recommendation system 286 may not be capable of identifying an alternative peripheral device 292 that is also an external display, and is capable of operative coupling with port 236 via the USB 2.0 communication protocol that is supported by port 236.

In an embodiment in which code instructions for the workspace capability informed peripheral device purchase recommendation system 286 have executed to identify an alternative peripheral device 292 that has communication protocol and power requirements that can be met by one or more available and operable ports 236 or 237, code instructions for the workspace capability informed peripheral device purchase recommendation system 286 may execute to further recommend, via the product purchase platform 273, that the user or ITDM purchase the alternative peripheral device 292, rather than the user-selected peripheral device 291. In an embodiment in which the workspace capability informed peripheral device purchase recommendation system 286 determines there are no alternative peripheral devices available for purchase that have communication protocol and power requirements that can be met by one or more available and operable ports 236 or 237, the method may proceed directly to block 412 and code instructions for the workspace capability informed peripheral device purchase recommendation system 286 may execute to identify a port hub or port adapter that the user may purchase in addition to the user-selected peripheral device 291 to operatively couple the user-selected peripheral device 291 to the anchor information handling system node 230.

At block 410, in an embodiment in which the workspace capability informed peripheral device purchase recommendation system recommends, via the product purchase platform, that the user purchase the alternative peripheral device, rather than the user-selected peripheral device, it may be determined by execution of code instructions for the workspace capability informed peripheral device purchase recommendation system whether the user accepted this recommendation. A graphical user interface may be generated for selection of the alternative peripheral device for purchase and the user may choose to accept or not to accept such an alternative peripheral device purchase recommendation. For example, the user may choose not to accept the alternative peripheral device purchase recommendation when the user perceives the user-selected peripheral device to be an upgrade from the alternative peripheral device recommended for purchase. More specifically, the user in an embodiment may refuse a recommendation to purchase an alternative webcam peripheral device 292 that communicates according to the USB 2.0 communication protocol supported by port 236 rather than the user-selected webcam peripheral device 291 that communicates according to the higher-quality USB-C communication protocol.

In other cases, the user may choose to accept an alternative peripheral device purchase recommendation that she perceives to be of the same quality, or an upgrade from the user-selected peripheral device. For example, the user in an embodiment may accept a recommendation to purchase an alternative external camera peripheral device 292 that communicates according to the USB-C communication protocol supported by port 237 rather than the user-selected external camera peripheral device 291 that communicates according to the lower-quality USB-A communication protocol.

If the user approves of the recommendation to purchase the alternative peripheral device, the workspace capability informed peripheral device purchase recommendation system may not interfere with the user's selected purchase of the alternative peripheral device via the product purchase platform and the method may then end. If the user does not approve of the recommendation, the method may proceed to block 412 for identification of port hubs or port adapters that that the user may purchase in addition to the user-selected peripheral device to operatively couple the user-selected peripheral device to the anchor node.

At block 412, in an embodiment in which the user does not approve of a recommended purchase of an alternative peripheral device, or in an embodiment in which no alternative peripheral devices could be identified, execution of code instructions of the workspace capability informed peripheral device purchase recommendation system may identify one or more alternative combinations of the user-selected peripheral device and port hubs or port adapters as additional peripheral devices to purchase having connectivity supported by available and operable ports at the anchor node. For example, code instructions for the workspace capability informed peripheral device purchase recommendation system 286 may have executed to have determined at block 408 that neither port 236 or 237 are capable of communication via the HDMI communication protocols, that port 237 is disabled, and that no alternative external display peripheral devices are capable of operative coupling with port 236 via the USB 2.0 communication protocol that is supported by port 236. In such an example embodiment, code instructions for the workspace capability informed peripheral device purchase recommendation system 286 may execute to identify one or more alternative combinations of the user-selected peripheral device 291 and a port hub 294 or port adapter 293 that is capable of operative coupling with the user-selected peripheral device 291 via the HDMI communication protocol required by the user-selected peripheral device 291 and that is capable of operative coupling with port 236 according to the USB 2.0 communication protocol.

As another example, code instructions for the workspace capability informed peripheral device purchase recommendation system 286 may have executed to determine at block 410 that the user has refused a recommendation to purchase an alternative webcam peripheral device 292 that communicates according to the USB 2.0 communication protocol supported by port 236 rather than the user-selected webcam peripheral device 291 that communicates according to the higher-quality USB-C communication protocol. In such an example embodiment, code instructions for the workspace capability informed peripheral device purchase recommendation system 286 may execute to identify one or more alternative combinations of the user-selected webcam peripheral device 291 and a port hub 294 or port adapter 293 that is capable of operative coupling with the user-selected webcam peripheral device 291 via the USB-C communication protocol required by the user-selected peripheral device 291 and that is capable of operative coupling with port 236 according to the USB 2.0 communication protocol.

At block 414, it may be determined in an embodiment by the workspace capability informed peripheral device purchase recommendation system whether the available and operable ports of the anchor node can meet the connectivity and power requirements for the identified combination of port adapter or port hub and the user-selected peripheral device. For example, code instructions for the workspace capability informed peripheral device purchase recommendation system 286 may execute to identify one or more alternative combinations of the user-selected peripheral device 291 and a port hub 294 or port adapter 293 that is capable of operative coupling with the user-selected peripheral device 291 via the HDMI communication protocol required by the user-selected peripheral device 291 and that is capable of operative coupling with port 236 according to the USB 2.0 communication protocol. Such a port hub 294 or port adapter 293 may not need to adhere to any specific power requirements as the HDMI operative coupling does not require power transfer from the anchor information handling system node 230 to the peripheral device 291, or vice versa. Thus, code instructions for the workspace capability informed peripheral device purchase recommendation system 286 may execute to determine that the combination of the available port 236 of the anchor information handling system node 230 and the port adapter 293 or port hub 294 can meet the power requirements and connectivity requirements, such as communication via the HDMI communication protocol, for the user-selected peripheral device 291.

As another example, code instructions for the workspace capability informed peripheral device purchase recommendation system 286 in an embodiment may execute to identify one or more alternative combinations of the user-selected peripheral device 291 and a port hub 294 or port adapter 293 that is capable of operative coupling with the user-selected peripheral device 291 via the USB-C communication protocol required by the user-selected peripheral device 291 and that is capable of operative coupling with port 236 according to the USB 2.0 communication protocol. Such a combination of the port adapter 293 or port hub 294 and the user-selected peripheral device 291 may still require power delivery via an operatively coupled port of 15 W, according to the USB-C communication protocol. Port 236, in contrast, may only be capable of delivering up to 2.5 W of power. Thus, code instructions for the workspace capability informed peripheral device purchase recommendation system 286 may execute to determine that the combination of the available port 236 of the anchor information handling system node 230 and the port adapter 293 or port hub 294 cannot meet the power requirements of up to 15 W for the user-selected peripheral device 291.

If an available and operable port of the anchor node can meet the connectivity and power requirements for the identified combination of port adapter or port hub and the user-selected peripheral device, the method may proceed to block 416 for recommendation that the user purchase the user-selected peripheral device in combination with the identified port hub or port adapter. If no available and operable ports of the anchor node can meet the connectivity and power requirements for the identified combination of port adapter or port hub and the user-selected peripheral device, the method may proceed to block 418 for recommendation that the user purchase a docking station in addition to the user-selected peripheral device.

In an embodiment at block 416 in which an available and operable port of the anchor node can meet the connectivity and power requirements for the identified combination of port adapter or port hub and the user-selected peripheral device, the workspace capability informed peripheral device purchase recommendation system may recommend that the user purchase an adapter or hub within an alternative combination identified at block 412 in addition to the purchase of the user-selected peripheral device. For example, code instructions for the workspace capability informed peripheral device purchase recommendation system 286 may execute at block 414 to determine that the combination of the available port 236 of the anchor information handling system node 230 and the port adapter 293 or port hub 294 can meet the power requirements and connectivity requirements, such as communication via the HDMI communication protocol, for the user-selected peripheral device 291. In such an example embodiment, code instructions for the workspace capability informed peripheral device purchase recommendation system 286 may execute to recommend that the user of anchor information handling system node 230 purchase the adapter 293 or hub 294 that is capable of operative coupling with the user-selected peripheral device 291 via the HDMI communication protocol required by the user-selected peripheral device 291 and that is capable of operative coupling with port 236 according to the USB 2.0 communication protocol in addition to the purchase of the user-selected peripheral device 291. The method for recommending user purchase of a port hub or port adapter, supplemental to a peripheral device selected by a user for purchase and incorporation into an existing peripheral device workspace, based on availability and functionality of ports in an anchor node information handling system of the existing peripheral device workspace may then end.

At block 418, in an embodiment in which no available and operable ports of the anchor node can meet the connectivity and power requirements for the identified combination of port adapter or port hub and the user-selected peripheral device, the workspace capability informed peripheral device purchase recommendation system may recommend user purchase of a docking station having connectivity supported by available ports at the anchor node and capable of meeting the user-selected peripheral device connectivity and power requirements, in addition to the purchase of the user-selected peripheral device. For example, code instructions for the workspace capability informed peripheral device purchase recommendation system 286 may execute at block 414 to determine that the combination of the available port 236 of the anchor information handling system node 230 and the port adapter 293 or port hub 294 cannot meet the power requirements of up to 15 W for the user-selected peripheral device 291. In such an example embodiment, code instructions for the workspace capability informed peripheral device purchase recommendation system 286 may execute to recommend that the user of anchor information handling system node 230 purchase the user-selected peripheral device 291 along with a docking station 295 having its own power source that is capable of delivering the 15 W required by the user-selected peripheral device 291.

In such a way, code instructions of the workspace capability informed peripheral device purchase recommendation system may be executed to work in tandem with the product purchase platform to recommend any extra hardware needed to support purchase of a user-selected peripheral device, based on the determined port availability and power capability limitations for an anchor node of the peripheral device workspace into which the user intends to incorporate the selected peripheral device for purchase. The method for recommending user purchase of a docking station, supplemental to a peripheral device selected by a user for purchase and incorporation into an existing peripheral device workspace, based on availability and functionality of ports in an anchor node information handling system of the existing peripheral device workspace may then end.

The blocks of the flow diagrams of FIGS. 3 and 4 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another may communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A peripheral device workspace cloud orchestrator executing at a cloud-based information handling system comprising:
a network interface device to receive a peripheral device operational telemetry data reading indicating one or more of a plurality of communication port functional capabilities for each of a plurality of information handling system communication ports at an anchor user information handling system node and for a first plurality of peripheral device nodes that have been previously operatively coupled to the anchor information handling system node at an identified location in a manifest of device nodes to form a defined first peripheral device workspace identified by a first peripheral device workspace identification value;
a hardware processor executing code instructions of the peripheral device workspace cloud orchestrator to identify an available port for communication via a communication protocol within the plurality of information handling system communication ports shown within the peripheral device operational telemetry data reading that is functional and available for operative coupling with a new peripheral device not listed in the manifest;
the hardware processor executing code instructions to generate a recommend user purchase of the new peripheral device that can operatively couple with the available port using the communication protocol.

2. The peripheral device workspace cloud orchestrator executing at the cloud-based information handling system of claim 1, wherein the available port for communication via the communication protocol within the plurality of information handling system communication ports is the Universal Serial Bus A (USB-A) protocol.

3. The peripheral device workspace cloud orchestrator executing at the cloud-based information handling system of claim 1, wherein the available port communication protocol is the Universal Serial Bus C (USB-C) protocol.

4. The peripheral device workspace cloud orchestrator executing at the cloud-based information handling system of claim 1 further comprising:
a network interface device to receive a user composite peripheral device workspace identifier for a user of the anchor information handling system node and selection input from a user to identify the first peripheral device workspace.

5. The peripheral device workspace cloud orchestrator executing at the cloud-based information handling system of claim 1 further comprising:
the hardware processor executing code instructions to instruct a product purchase platform executing at a remote vendor server to filter user search results for potential purchase of the new peripheral device to include a plurality of available peripheral devices for purchase from the product purchase platform that can operatively couple with the available port using the communication protocol.

6. The peripheral device workspace cloud orchestrator executing at the cloud-based information handling system of claim 1 further comprising:
the network interface device to receive a user selection of a potential new peripheral device for incorporation within the first peripheral device workspace;
the hardware processor executing code instructions to determine none of one or more functional and available ports for communication within the plurality of information handling system communication ports, as identified within the peripheral device operational telemetry data reading meet the communication protocol requirement for the potential new peripheral device; and
the hardware processor executing code instructions to generate a second recommend user purchase of an alternative peripheral device as the new peripheral device instead of the potential new peripheral device.

7. The peripheral device workspace cloud orchestrator executing at the cloud-based information handling system of claim 1 further comprising:
the hardware processor executing code instructions to determine that the new peripheral device has power requirements that can be met by a power delivery capability for the available port and can be operatively coupled with the available port using the communication protocol through reference to an orchestrated device descriptor (ODD) for the new peripheral device stored in a database at the peripheral device workspace cloud orchestrator.

8. A method of executing code instructions of a workspace capability informed peripheral device purchase recommendation system on a peripheral device workspace cloud orchestrator server for recommending purchase of a peripheral device for use within a defined peripheral device workspace comprising:
receiving, via a network interface device of the peripheral device workspace cloud orchestrator server, a peripheral device operational telemetry data reading indicating one or more of a plurality of communication port functional capabilities for each of a plurality of information handling system communication ports at an anchor information handling system node and for a first plurality of peripheral device nodes that have been previously operatively coupled to the user information handling system at an identified location and listed within a manifest of device nodes to form a defined first peripheral device workspace identified by a first peripheral device workspace identification value;
receiving from a product purchase platform, via the network interface device, a user selection of a potential new peripheral device for incorporation within the first peripheral device workspace having a communication protocol requirement;
determining, via a hardware processor executing code instructions, that none of one or more functional and available ports for communication within the plurality of information handling system communication ports, as identified within the peripheral device operational telemetry reading meet a communication protocol requirement and a power requirement for the potential new peripheral device of a defined peripheral device type;
identifying, via the hardware processor executing code instructions, a port adapter, a port hub, or a docking station capable of operative coupling with the one or more functional and available ports and with the potential new peripheral device via one or more communication protocols meeting the communication protocol requirement for the potential new peripheral device; and
the hardware processor executing code instructions to recommend that a user purchase the potential new peripheral device and purchase the port adapter, the port hub, or the docking station.

9. The method of claim 8 further comprising:
determining, via the hardware processor executing code instructions, that the potential new peripheral device has a power requirement that cannot be met by a power delivery capability for the functional and available ports from the peripheral device operational telemetry data reading in combination with the port adapter or the port hub; and
recommending, via the hardware processor executing code instructions, that the user purchase the potential new peripheral device and the docking station.

10. The method of claim 8 further comprising:
determining, via the hardware processor executing code instructions, that a power delivery capability for the functional and available port given from the peripheral device operational telemetry data reading, in combination with the port adapter or the port hub, meets a power requirement for the potential new peripheral device; and
recommending, via the hardware processor executing code instructions, that the user purchase the potential new peripheral device and the port adapter or the port hub.

11. The method of claim 8 further comprising:
determining, via the hardware processor executing code instructions, that the port adapter, the port hub, or the docking station are capable of operative coupling with the one or more functional and available ports and with the potential new peripheral device via one or more communication protocols meeting the communication protocol requirement for the potential new peripheral device through reference to an orchestrated device descriptor (ODD) for the alternative new peripheral device stored in a database memory at the peripheral device workspace cloud orchestrator server.

12. The method of claim 8 further comprising:
determining a user composite peripheral device workspace identifier for the user of the anchor information handling system node from a user identification that further identifies a plurality of peripheral device workspaces that includes the first peripheral device workspace accessed by the user; and
instructing, via the hardware processor executing code instructions to generate a graphical user interface, the user to identify which of the plurality of peripheral device workspaces into which the user will incorporate the potential new peripheral device.

13. The method of claim 8 further comprising:
receiving from a product purchase platform, via the network interface device, with the user selection of the potential new peripheral device for incorporation within the first peripheral device workspace a power requirement for the potential new peripheral device.

14. The method of claim 8 further comprising:
identifying, via the hardware processor executing code instructions, the port adapter, the port hub, or the docking station capable of operative coupling with the one or more functional and available ports to meet the power requirement for the potential new peripheral device.

15. A peripheral device workspace cloud orchestrator executing at a cloud-based information handling system comprising:
a network interface device to receive a peripheral device operational telemetry data reading indicating one or more of a plurality of communication port functional capabilities for each of a plurality of information handling system communication ports at an anchor information handling system node and for a first plurality of peripheral device nodes that have been previously operatively coupled to the user information handling system at an identified location to form a defined first peripheral device workspace identified by a first peripheral device workspace identification value;
the network interface device to receive a user selection of a potential new peripheral device from a product purchase platform executing at a vendor server for incorporation within the first peripheral device workspace;
a hardware processor executing code instructions of the peripheral device workspace cloud orchestrator to determine that one or more functional and available ports for communication within the plurality of information handling system communication ports, as identified within the peripheral device operational telemetry data reading, meet a communication protocol requirement and a power requirement for the potential new peripheral device of a defined peripheral device type; and
the hardware processor executing code instructions to recommend, via the product purchase platform, that a user purchase the potential new peripheral device that can operatively couple with the one or more functional and available ports using the communication protocol supporting the communication protocol requirement and the one or more functional and available ports having power delivery capabilities meeting the power requirement for the potential new peripheral device.

16. The peripheral device workspace cloud orchestrator of claim 15 further comprising:
the hardware processor executing code instructions to determine that the potential new peripheral device can operatively couple with the one or more functional and available ports using a communication protocol supported by the one or more functional and available ports through reference to an orchestrated device descriptor (ODD) for the potential new peripheral device stored in a database operatively coupled to the cloud-based information handling system.

17. The peripheral device workspace cloud orchestrator of claim 15 further comprising:
a hardware processor executing code instructions of the peripheral device workspace cloud orchestrator to determine that the one or more functional and available ports for communication within the plurality of information handling system communication ports does not meet a communication protocol requirement and a power requirement for the potential new peripheral device of a defined peripheral device type; and
the hardware processor executing code instructions to recommend, via the product purchase platform, user purchase of an alternative new peripheral device of the defined peripheral device type that can operatively couple with the available port using the communication protocol supported by the one or more functional and available ports and the one or more functional and available ports having power delivery capabilities meeting a second power requirement for the alternative new peripheral device.

18. The peripheral device workspace cloud orchestrator of claim 15 further comprising:
the network interface device to receive a user composite peripheral device workspace identifier for a user of the user information handling system from the product purchase platform that identifies a plurality of peripheral device workspaces; and
the hardware processor executing code instructions to instruct the user to identify which of the plurality of peripheral device workspaces into which the user will incorporate the potential new peripheral device.

19. The peripheral device workspace cloud orchestrator of claim 15, wherein the port communication protocol for the one or more available communication ports is a high definition multimedia interface (HDMI) protocol.

20. The peripheral device workspace cloud orchestrator of claim 15, wherein the power requirement for the potential new peripheral device is equal to or greater than 100 Watts.
